(19) United States
(12) Patent Application Publication
(10) Pub. No.: US 2009/0228854 A1
(43) Pub. Date: Sep. 10, 2009

(54) Wiring model library constructing device and constructing method, and layout parameter extracting device and extracting method

(75) Inventor: Hideo Sakamoto, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/379,765

(22) Filed: Feb. 27, 2009

(30) Foreign Application Priority Data
Mar. 7, 2008 (JP) 2008-058187

(51) Int. Cl. G06F 17/50

(52) U.S. Cl. 716/10

(57) ABSTRACT

A wiring model library constructing method includes: obtaining a correction value of wiring widths on the basis of a plurality of first wiring area ratios and a first wiring film thickness of a plurality of first subject wirings in a plurality of first test wiring patterns each having the first subject wiring and a plurality of first peripheral wrings and being different in the wiring width and wiring interval from each other, obtaining a relationship between the wiring film thickness and the corrected wiring area ratio on the basis of a plurality of second wiring area ratios corrected with the correction value and a second wiring film thickness of a plurality of second subject wirings in a plurality of patterns including at least one of a plurality of inner patterns in each of a plurality of second test wiring patterns including the plurality of first inner patterns each having the second subject wiring and a plurality of second peripheral wirings and being different in the wiring width and wiring interval from each other, and storing data indicative of a relationship of the correction value, the wiring thickness, and the corrected wiring area ratio in association with the wiring width in a storage unit.

### BACKGROUND OF THE INVENTION

1. Field of the Invention

The present invention relates to a wiring model library constructing device, a wiring model library constructing method, a layout parameter extracting device, and a layout parameter extracting method for wiring used in a semiconductor device.

2. Description of Related Art

In a circuit design of a semiconductor device, there have been known a method of modeling a wiring and a method of extracting a layout parameter (exemplification: wiring resistance, wiring capacity) on the basis of a modeled wiring. The circuit design and circuit simulation are conducted on the basis of the wiring resistance and the wiring capacity for wiring which are extracted by using those methods. On the other hand, the wiring really formed in the semiconductor device is affected by a manufacturing process, and is deviated from a designed value (layout dimension) after manufacturing. For example, when a date rate (wiring density) is high, an erosion phenomenon occurs in a CMP (chemical mechanical polishing) process of wiring. In this case, a film for wiring is deeply ground as compared with the periphery, and the thickness of the wiring is thinned. The modulation of a wiring configuration generated by an influence of such a manufacturing process causes an error between the wiring resistance and wiring capacity used for circuit simulation at the time of circuit design, and a real wiring resistance and wiring capacity.

The influence of such an error tends to be larger with the more miniaturized semiconductor device. For that reason, there has been proposed a method of estimating the amount of modulation of the wiring configuration affected by the manufacturing process in advance. The use of that method makes it possible to predict the wiring configuration with precision, estimate the wiring resistance and wiring capacity characteristics, and reflect the characteristics to the circuit design. As this method, Japanese Unexamined Patent Application Publication (JP-A) No. 2003-108622 (Japanese Patent application No: JP 2001-295987, filing date: Sep. 27, 2001, corresponding to US Patent application US 2003057571A1) discloses a wiring modeling method, a wiring model, a wiring model extracting method, and a wiring designing method.

In the wiring modeling method, first, in a semiconductor device with a wiring, an arbitrary region of the semiconductor device is selected. Then, a wiring area ratio of the wiring occupied in the region is calculated. Then, the region and the wiring area ratio are determined, thereby modeling the cross-sectional configuration of a subject wiring positioned at a central portion of the region. Also, in the wiring designing method, first in a semiconductor device test pattern with a wiring, an arbitrary region of the semiconductor device test pattern is selected. Then, a wiring area ratio of the wiring occupied in the region is calculated. Subsequently, the region and the wiring area ratio are determined, thereby modeling the cross-sectional configuration of a subject wiring positioned at a central portion of the region. Thereafter, a difference between the designed value of the subject wiring and a model value of the subject wiring is calculated as a correction value. Then, a semiconductor device including a wiring designed by the same design rule as that of the subject wiring is designed on the basis of a designed value that adjusts the designed value of the subject wiring with the correction value. In this way, in the wiring modeling method, there has been proposed a method of modeling the manufacturing process with precision, and estimating the wiring resistance and the wiring capacity with high precision at the time of circuit design.

As the related art, JP-A No. 2001-230323 discloses a circuit parameter extracting method, a designing method and device for a semiconductor integrated circuit. The circuit parameter extracting method is a method of extracting the circuit parameter such as the wiring resistance or the wiring capacity from the layout of the semiconductor integrated circuit. In the circuit parameter extracting method, correlation data of a distance between a model wiring and a wiring on the same layer which exists around the model wiring, and a difference between a mask layout width of the model wiring and a finished width is first prepared. Then, a wiring length and a wiring width of an analysis wiring are extracted from a real layout, and a distance between the analysis wiring and a wiring existing around the analysis wiring on the same layer is extracted. Then, the wiring resistance value and the wiring capacity value are calculated with the use of the finished wiring width obtained by referring to the correlation data for the extracted layout wiring width of the analysis wiring and the similarly extracted distance between the analysis wiring and the wiring existing around the analysis wiring.

Also, JP-A No. 2005-294852 (a divisional application of the above JP-A No. 2001-230323) discloses a circuit parameter extracting method, and a designing method and device for a semiconductor integrated circuit. In the designing method for the semiconductor integrated circuit, there are first prepared first correlation data of a gate electrode pattern area ratio and a finished gate length dimension, and second correlation data of a transistor drive current value, a threshold value, and an operation speed in a model circuit. Then, a gate electrode pattern area ratio of the semiconductor integrated circuit to be designed is calculated with an entire chip as an area to be designed. Referring to the first and second correlation data for the calculated gate electrode pattern area ratio, the operation speed range of the semiconductor integrated circuit to be designed is corrected to a side where the circuit operation speed is low when the gate electrode pattern area ratio is high, and a side where the circuit operation speed is high when the gate electrode pattern area ratio is low, and thereafter timing verification simulation is executed.

Further, JP-A No. 2007-080942 discloses a wiring modeling method and a dummy pattern generating method. The wiring modeling method models the thickness of the wiring in the semiconductor integrated circuit made up of basic elements and wirings connecting among those elements. In the wiring modeling method, an arbitrary region A including a wiring pattern P whose film thickness is to be determined is first selected. Then, a wiring area ratio α that is a ratio of the wiring occupied in the region A on the same layer as that of the wiring pattern P is calculated. Subsequently, a wiring area ratio β that is a ratio of the wiring occupied in an arbitrary region B on a lower layer of the wiring pattern P is calculated. Then, the wiring thickness of the wiring pattern P is obtained from the wiring area ratio α and the wiring area ratio β.
[Patent Document 1] JP-A No. 2003-108622
[Patent Document 2] JP-A No. 2001-230323
[Patent Document 3] JP-A No. 2005-294852
[Patent Document 4] JP-A No. 2007-080942

### SUMMARY

Hereinafter, a description will be given of calculation of a wiring film thickness T necessary for calculation of a wiring resistance and a wiring capacity. FIGS. 1A and 1B are diagrams showing an example of a relationship between a layout dimension of wiring in a CMP process and a real wiring configuration. FIG. 1A is a top view showing a layout dimension (designed value) of wiring. FIG. 1B is a cross-sectional view showing the real wiring configuration. In this case, as shown in FIG. 1A, there is exemplified a pattern 151 in which wirings 152 with the same wiring width W (designed value) are repetitively spread at the same wiring intervals S (designed value) in a sufficiently wide range within an interlayer insulation film 153.

As shown in FIG. 1B, a cross section of wirings 162 in a real pattern 160 is trapezoidal. The reason that the wiring 162 is trapezoidal is stated below. The wirings of an LSI (exemplification: Cu wiring) are produced in a process of plating a metal film 166 for the wiring 162 on wiring grooves 164 defined within the interlayer insulation film 165 after etching the wiring grooves 164. In this example, in recent years, because the wiring grooves 164 are narrowed with miniaturization of the LSI, there is a possibility that the burying property of the plated metal film 166 is deteriorated. For that reason, the frontage of each of the wiring grooves 164 is widened into a trapezoidal configuration, thereby improving the burying property of the plated metal film 166. In this way, the configuration of the real wirings 162 is trapezoidal, and the wiring width is larger toward the upper portion of the wirings.

The real wirings 162 are intentionally manufactured in such a manner that the wiring width W of the wirings 152 on the design (layout) becomes a wiring width at a position (T2) of half the wiring thickness T of the real wirings 162. In this case, an influence of the etching process for the wiring grooves 164 on the wiring grooves 164 has a pattern dependency, and the amount of modulation is different depending on the width of the wiring grooves 164. Accordingly, intentional manufacturing is conducted so that the wiring width coincides with the designed value at half (T2) the wiring film thickness T of the pattern.

In this example, the CMP process grinds the interlayer insulation film 165 and the metal film 166 until the wirings 162 reach a target wiring film thickness T. At that time, ease to grind is different depending on the wiring data ratio (wiring density) Deff of the periphery of the subject wiring 162. For that reason, the wiring film thickness T of the finished wirings is different depending on the wiring data ratio Deff (erosion phenomenon). When the wiring data ratio Deff is large, since grinding is easy, the smaller wiring film thickness T is finished. On the contrary, when the wiring data ratio Deff is small, since grinding is difficult, the larger wiring film thickness T is finished. This is because the wiring portions are easily ground by CMP, but oxide film portions are difficult to grind.

As usual, in the case of calculating the wiring data ratio Deff, calculation is conducted by using the wiring width W and the wiring interval S being the designed values. For example, when the wirings are uniformly spread with the wiring widths W and the wiring intervals S as shown in FIG. 1A, the wiring data ratio Deff can be calculated by the following Expression (1).

Deff=W/(W+S) (1)

In general, the wiring data ratio Deff can be calculated by the following Expression (2).

Deff=we(X1)×D(X1)+we(X2)×D(X2)+we(X3)×D(X3)+ . . . (2)

where D(Xi): a wiring data ratio in an Xi×Xi region centered on a subject wiring, and we(Xi): weighting coefficient by which D(Xi) is multiplied (total=1).

That is, the wiring data ratio Deff is expressed by the weighted average efficiency of the wiring data ratios D(Xi) in the respective regions (Xi×Xi, I=1, 2, 3, . . . ) centered on the subject wiring. Also, the number of definitions of D(Xi), we(Xi), and Xi are parameters set in each of the processes.

FIG. 2 is a graph showing a relationship between the wiring film thickness T and the wiring data ratio Deff in the erosion phenomenon. The axis of ordinate is the wiring film thickness T, and the axis of abscissa is the wiring data ratio Deff. In the erosion phenomenon in the CMP process, the wiring film thickness T of the subject wiring is linearly decreased with respect to the data ratio Deff. This is generally expressed by a model function of the following Expression (3) (straight line P). In this case, a slope “Slope” is a proportional constant indicative of the sensitivity of erosion to the wiring data ratio Deff. The value of the slope “Slope” has a value specific to the process condition of the CMP or a material of the film.

T(W, S, Deff)=Slope×(Deff−0.5)+T05 (W, S) (3)

where T05 is the film thickness of the wiring when the wiring data ratio Deff=0.

In this way, in the above method, the wiring data ratio Deff is calculated through Expression (2) by using the designed value (the wiring width and the wiring interval at the intermediate height of the wiring), and the wiring film thickness T is calculated through Expression (3) by using the calculated wiring data ratio Deff. The wiring film thickness T is used as one of the values of the wiring configuration when calculating the wiring resistance and the wiring capacity used in the circuit design of the LSI.

Now, the following fact has been proved by the inventors' study.

In recent years, the miniaturization of the wiring process is advanced, and the wiring width W is further narrowed. For that reason, as shown in FIG. 1B, since the cross-sectional configuration of the wirings 162 is trapezoidal, it has been proved that an influence of a difference between the wiring width W0 of the wiring 162 surface and the wiring width W of the designed value (=the wiring width at the intermediate height of the wiring 162) becomes as large as the influence cannot be ignored. That is, the real wiring width W0 of a portion ground by the CMP is larger than the wiring width W of the designed value. For that reason, the wiring data ratio Deff calculated from the wiring width W of the designed value originally has an error with respect to the effective wiring data ratio Deff based on the real wiring width W0. It has been proved that an influence of the error is as large as the error cannot be ignored due to the miniaturization of the recent wiring process. This is shown in FIG. 3.

FIG. 3 is a graph showing an influence of a difference between the real wiring width and the wiring width of the designed value with respect to a relationship of the wiring film thickness T and the wiring data ratio Deff. The axis of ordinate is the wiring film thickness T, and the axis of abscissa is the wiring data ratio Deff. In an example of the drawing, circle marks show a relationship between the wiring film thickness T and both of the effective wiring data ratio Deff based on the real wiring width W0 and the wiring data ratio Deff calculated from the designed value (common). Triangle marks show a relationship between the wiring film thickness T and only the wiring data ratio Deff calculated from the designed value. Square marks show a relationship between the wiring film thickness T and only the effective wiring data ratio Deff based on the real wiring width W0. The straight line P shows a model function ofthe above Expression (3).

As shown in the figure, a difference between the effective wiring data ratio and the wiring data ratio of the designed value is remarkable at a higher side of the wiring data ratio. For example, in some wiring pattern, the effective wiring data ratio Deff is about 0.8 (square marks), but the wiring data ratio Deff of the designed value is about 0.5 (triangle marks). As a result, the wiring data ratio Deff is largely deviated from the real wiring data ratio Deff. In this way, it has been proved that with the high integration of the recent LSI, the measured points at which the wiring data ratio dependency of the wiring film thickness T does not meet Expression (3) (straight line P) occur. Then, it has been proved that such a phenomenon becomes particularly remarkable when the wiring width is small, and the wiring interval is small. The deviation of the wiring data ratio induces a deviation of the film thickness of the wiring really produced from the film thickness of the circuit design from Expression (3). In this case, the deviation induces a wiring resistance error or a wiring capacity error with the result that a design error is generated.

In the circuit design of the semiconductor device, a technique by which the wiring data ratio based on the wiring data ratio can be more accurately calculated is desired. A technique by which the wiring resistance and wiring capacity based on the wiring film thickness can be more precisely calculated is desired.

A wiring model library constructing method according to an exemplary aspect of the present invention includes obtaining a correction value (dw) of wiring widths (W, WD) on the basis of a plurality of first wiring area ratios (Deff) and a first wiring film thickness (T) of a plurality of first subject wirings (52) in a plurality of first test wiring patterns (50) each having the first subject wiring (52) and a plurality of first peripheral wrings (54) and being different in the wiring width (W, WD) and wiring interval (S, SD) from each other; obtaining a relationship between the wiring film thickness (T) and the corrected wiring area ratio (Deff) on the basis of a plurality of second wiring area ratios (D1, D2, D3) corrected with the correction value (dw) and a second wiring film thickness (T) of a plurality of second subject wirings (72) in a plurality of patterns including at least one of a plurality of inner patterns (81, 82, 83) in each of a plurality of second test wiring patterns (80) including the plurality of first inner patterns (81, 82, 83) each having the second subject wiring (72) and a plurality of second peripheral wirings (74, 76, 78) and being different in the wiring width (W, WD1, WD2, WD3) and wiring interval (S, SD1, SD2, SD3) from each other; and storing data indicative of a relationship of the correction value (dw), the wiring thickness (T), and the corrected wiring area ratio (Deff) in association with the wiring width (W) in a storage unit.

When the CMP process is considered, an error is included in the wiring area ratio (Deff) calculated from a technique in which the wiring width (W) of the designed value is not corrected. However, in the wiring model library constructing method according to the present invention, the correction value (dw) taking the CMP process into consideration is extracted, thereby making it possible to calculate a physically correct wiring area ratio (Deff). As a result, it is possible to cancel the model error occurring when using a technique in which the wiring width (W) is not corrected. Also, a more precise wiring model (data indicative of a relationship between the wiring film thickness (T) and the wiring area ratio (Deff)) can be calculated in correspondence with the more precise wiring area ratio (Deff) caused by introduction of the correction value (dw). As a result, it is possible to more precisely calculate the wiring film thickness (T) necessary for determination of the wiring configuration.

A layout parameter extracting method according to an exemplary aspect of the present invention includes: extracting a correction value (dw) of a subject wiring (92) from first data (42) associating a wiring width stored in a storage unit (37) with a correction value on the basis of the wiring width (W) of the subject wiring (92) extracted from layout data (41) stored in the storage unit (37) to correct the wiring width (W) of the subject wiring (92) with the extracted correction value (dw); extracting a first wiring model parameter (i, xi, we(Xi)) related to the wiring area ratio of the subject wiring (92) from second data (42) stored in the storage unit (37) on the basis of the corrected wiring width (Wa) of the subject wiring (92), and stored to associate the corrected wiring width with the wiring model parameter to calculate the wiring area ratio (Deff) of the subject wiring (92) on the basis of the corrected wiring width (Wa) of the subject wiring (92) and the first wiring model parameter; extracting a second wiring model parameter (Slop, T05) related to the wiring film thickness from the second data on the basis of the corrected wiring width (Wa) of the subject wiring (92) to calculate a wiring film thickness (T) of the subject wiring (92) on the basis of the second wiring model parameter and the wiring area ratio (Deff) of the subject wiring (92); determining the wiring configuration of the subject wiring (92) on the basis of the wiring width (W), a wiring interval (S), and a wiring length (L) of the subject wiring (92) which are extracted from the layout data (41), and the wiring film thickness (T) of the subject wiring (92); and calculating a wiring resistance and a wiring capacity related to the subject wiring (92) on the basis of third data (43) stored in the storage unit (37) and associating the wiring capacity with the wiring configuration, and the wiring configuration of the subject wiring (92).

In the layout parameter extracting method according to the aspect of the present invention, a concept of the correction value (dw) introduced in the above wiring model library constructing method is used. That is, the first data (42, exemplification: FIG. 16A), the first wiring model parameter (i, Xi, we(Xi), exemplification: FIGS. 16B to 16D) of the second data (42), and the second wiring model parameter (Slope, T05, exemplification: FIGS. 16E to 16F) of the second data (42) are used. Accordingly, it is possible to more precisely determine the wiring film thickness (T). As a result, since the wiring configuration using the wiring film thickness (T) can be more precisely determined, it is possible to more precisely calculate the wiring resistance and the wiring capacity.

According to the exemplary aspect of the present invention, in the circuit design of the semiconductor device, it is possible to more properly calculate the wiring data. Also, it is possible to more precisely calculate the wiring film thickness based on the wiring data ratio. Then, it is possible to more precisely calculate the wiring resistance and the wiring capacity based on the wiring film thickness.

### BRIEF DESCRIPTION OF THE DRAWINGS

The above and other exemplary aspects, advantages and features of the present invention will be more apparent from the following description of certain exemplary embodiments taken in conjunction with the accompanying drawings, in which:

FIG. 1A is a top view showing the layout dimensions of wirings in a CMP process;

FIG. 1B is a cross-sectional view showing a real wiring configuration in the CMP process;

FIG. 2 is a graph showing a relationship between the wiring film thickness T and a wiring data ratio Deff in an erosion phenomenon;

FIG. 3 is a graph showing an influence of a difference between a real wiring width and a wiring width of a designed value with respect to a relationship of the wiring film thickness T and the wiring data ratio Deff;

FIG. 4 is a cross-sectional view showing the wiring that has been subjected to the CMP process;

FIG. 5 is a top view showing the wirings before and after correction with the correction value dw in the case of calculating the wiring data ratio in the exemplary embodiment of the present invention;

FIG. 6 is a block diagram showing the configuration of a wiring model library constructing device according to an exemplary embodiment of the present invention;

FIG. 7 is a top view showing a TEG pattern for dw extraction in the exemplary embodiment of the present invention;

FIG. 8 is a table showing a standard example of the TEG pattern in FIG. 7;

FIG. 9 is a cross-sectional view showing the wiring after the CMP process has been completed;

FIG. 10A is a table showing a wiring model table a according to the exemplary embodiment of the present invention;

FIG. 10B is a table showing the wiring model table a according to the exemplary embodiment of the present invention;

FIG. 10C is a table showing the wiring model table a according to the exemplary embodiment of the present invention;

FIG. 10D is a table showing the wiring model table a according to the exemplary embodiment of the present invention;

FIG. 10E is a table showing the wiring model table a according to the exemplary embodiment of the present invention;

FIG. 11 is a graph showing a relationship between the wiring film thickness T and the wiring data ratio Deff;

FIG. 12 is a graph showing a relationship between the wiring film thickness T and the effective wiring data ratio Deff;

FIG. 13A is a top view showing a TEG pattern for wiring model parameter extraction according to the exemplary embodiment of the present invention;

FIG. 13B is a partially top view showing the TEG pattern for wiring model parameter extraction according to the exemplary embodiment of the present invention;

FIG. 14 is a table showing a standard example of the TEG pattern in FIGS. 13A and 13B;

FIG. 15 is a graph showing a relationship between the wiring film thickness T and the wiring data ratio Deff by using the wiring data ratio Deff;

FIG. 16A is a table showing a wiring model table b according to the exemplary embodiment of the present invention;

FIG. 16B is a table showing the wiring model table b according to the exemplary embodiment of the present invention;

FIG. 16C is a table showing the wiring model table b according to the exemplary embodiment of the present invention;.

FIG. 16D is a table showing the wiring model table b according to the exemplary embodiment of the present invention;

FIG. 16E is a table showing the wiring model table b according to the exemplary embodiment of the present invention;

FIG. 16F is a table showing the wiring model table b according to the exemplary embodiment of the present invention;

FIG. 17 is a graph showing a relationship between the correction value dw and the wiring width WD or the wiring interval SD of the peripheral wirings;

FIG. 18 is a flowchart showing a wiring model library constructing method according to the exemplary embodiment of the present invention;

FIG. 19 is a block diagram showing the configuration of a layout parameter extracting device according to the exemplary embodiment of the present invention;

FIG. 20 is a flowchart showing a layout parameter extracting method according to the exemplary embodiment of the present invention;

FIG. 21 is a schematic diagram showing a semiconductor device applied with the layout parameter extracting method according to the exemplary embodiment of the present invention;

FIG. 22 is a graph showing the effect of the layout parameter extracting method according to the exemplary embodiment of the present invention;

FIG. 23 is a graph showing the measured data in a calculating method using no correction value dw; and

FIG. 24 shows the measured data in the calculating method using the correction value dw according to the exemplary embodiment of the present invention.

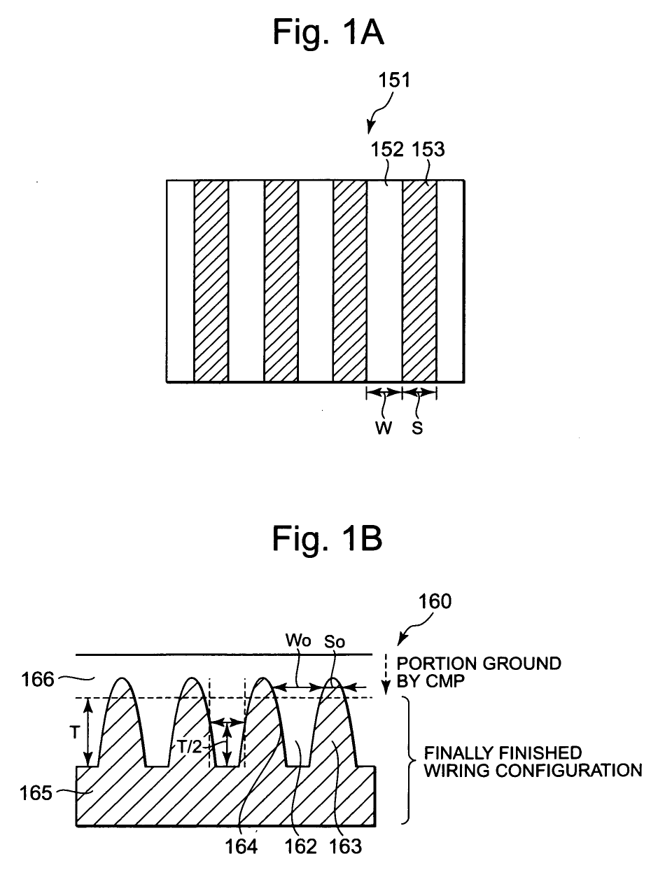

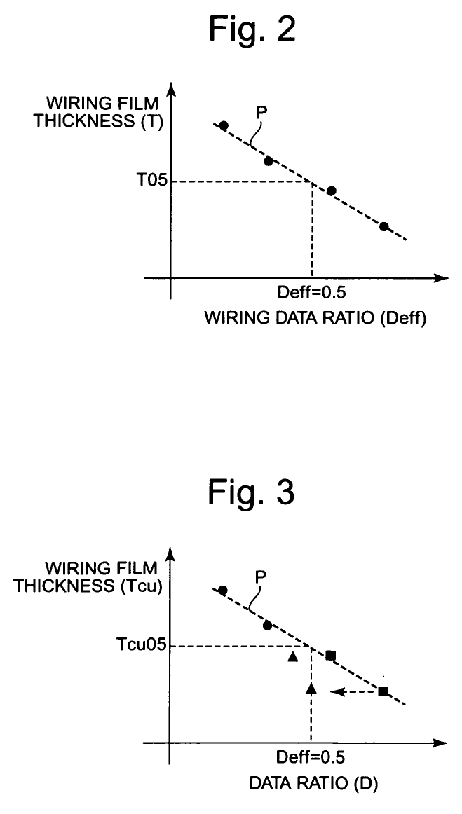

### DETAILED DESCRIPTION OF THE EXEMPLARY EMBODIMENTS

Hereinafter, exemplary embodiments of a wiring model library constructing device, a wiring model library constructing method, a layout parameter extracting device, and a layout parameter extracting method will be described with reference to the accompanying drawings.

First, a basic concept used in the present invention will be described. In the present invention, in the wiring that has been subjected to a CMP process, an effective wiring data ratio is extracted (calculated) with the use of not a layout dimension (wiring film thickness=wiring width and wiring interval at T2) but a substantial dimension (wiring film thickness=wiring width and wiring interval at T(wiring surface)). This matter will be described below.

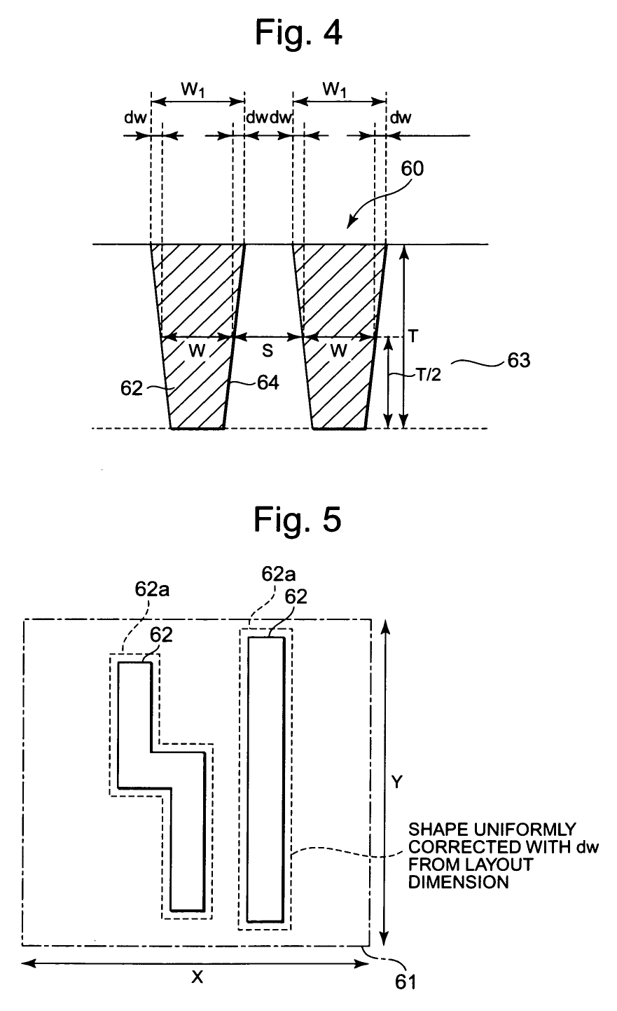

First, let us consider a cross section of the wiring that has been subjected to the CMP process. FIG. 4 is a cross-sectional view showing the wiring that has been subjected to the CMP process. In a real pattern 60, a cross section of wirings 62 (wiring grooves 64) defined in an interlayer insulation film 63 is trapezoidal, and the wirings 62 are widened upward. For that reason, when the wirings are ground by the CMP, a wiring width W1 (wiring width at wiring film thickness=T) of the most front surface of the wiring 62 is necessarily larger than the wiring width W (wiring width at wiring film thickness=T2) corresponding to the designed value. Accordingly, the effective wiring data ratio (wiring data ratio at wiring film thickness=T) that has been subjected to the CMP is larger than the wiring data ratio (wiring data ratio at wiring film thickness=T2) calculated from the designed value. A difference between both of those wiring data ratios cannot be ignored by an influence of miniaturization in the recent semiconductor device. For that reason, in the present invention, the effective wiring data ratio (wiring data ratio at film thickness=T) which has been subjected to the CMP is used.

In the case of obtaining the effective wiring data ratio, the wiring width W1 of the most front surface of the wiring 62 is defined as W1=W+2×dw as shown in FIG. 4. Reference symbol dw is a correction value of the wiring width. In this case, a value of 2×dw is, for example, about 0.01 μm to 0.09 μm, which is a sufficiently small value as compared with the wiring with a bold width of several μm. FIG. 5 is a top view showing the wirings before and after correction with the correction value dw in the case of calculating the wiring data ratio in the exemplary embodiment of the present invention. When a wiring data ratio D in a certain region 60 (X×Y) is calculated, correction is made such that all of the wiring widths (designed values) of the wirings 62 existing in a certain region 61 are equally thickened by the correction value dw to provide wirings 62a. A total area of the wirings 62a obtained by correction is divided by an area x×Y of the region 60 calculating the wiring data ratio to provide the wiring data ratio D at that time. The calculation expression is expressed by the following Expression (4). In the present invention, the wiring data ratio obtained by using Expression (4) is substituted for D(Xi) of the respective terms in Expression (3) to calculate the wiring data ratio Deff. As a result, more precise design is enabled.

D=(total area of the wirings after dw correction)/(area of the calculation region of the wiring data ratio) (4)

Hereinafter, exemplary embodiments of the present invention will be described in detail.

First, a description will be given of the configuration of a wiring model library constructing device according to an exemplary embodiment of the present invention.

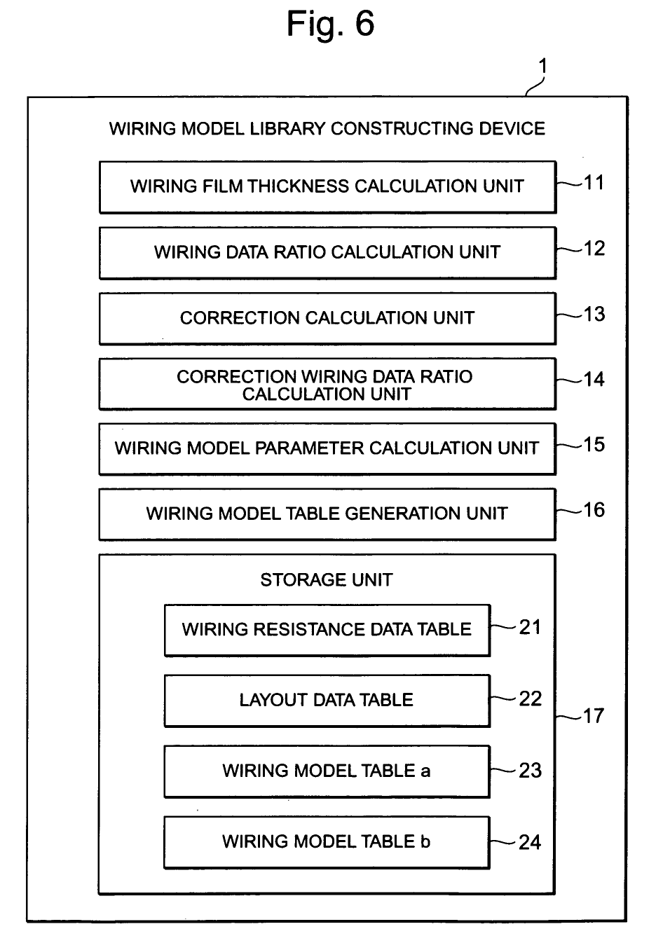

FIG. 6 is a block diagram showing the configuration of a wiring model library constructing device according to an exemplary embodiment of the present invention. A wiring model library constructing device 1 functions as a wiring model library device 1 of the present invention in which a wiring model production program (wiring model library constructing method) according to the present invention is installed in an information processing unit exemplified by a personal computer. The wiring model library device 1 includes a wiring film thickness calculation unit 11, a wiring data ratio calculation unit 12, a correction calculation unit 13, a correction wiring data ratio calculation unit 14, a wiring model parameter calculation unit 15, a wiring model table generation unit 16, and a storage unit 17.

The storage unit 17 is a storage device mounted in the information processing unit, which is exemplified by an HDD (hard disc drive) or a semiconductor memory. The storage unit 17 includes a wiring resistance data table 21, a layout data table 22, a wiring model table a 23, and a wiring model table b 24.

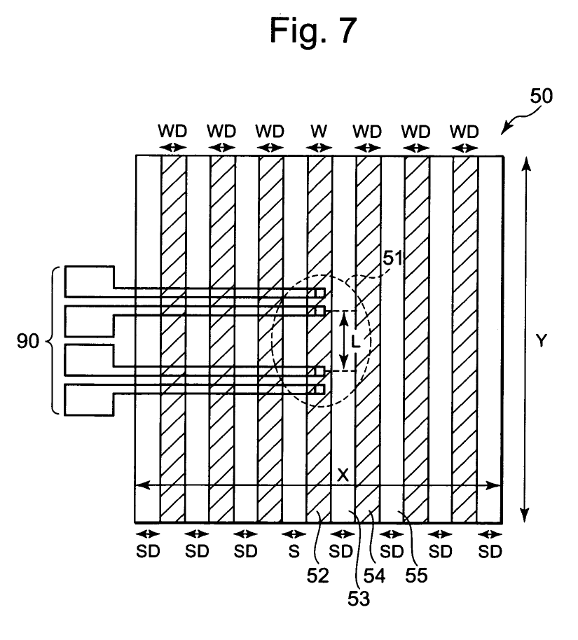

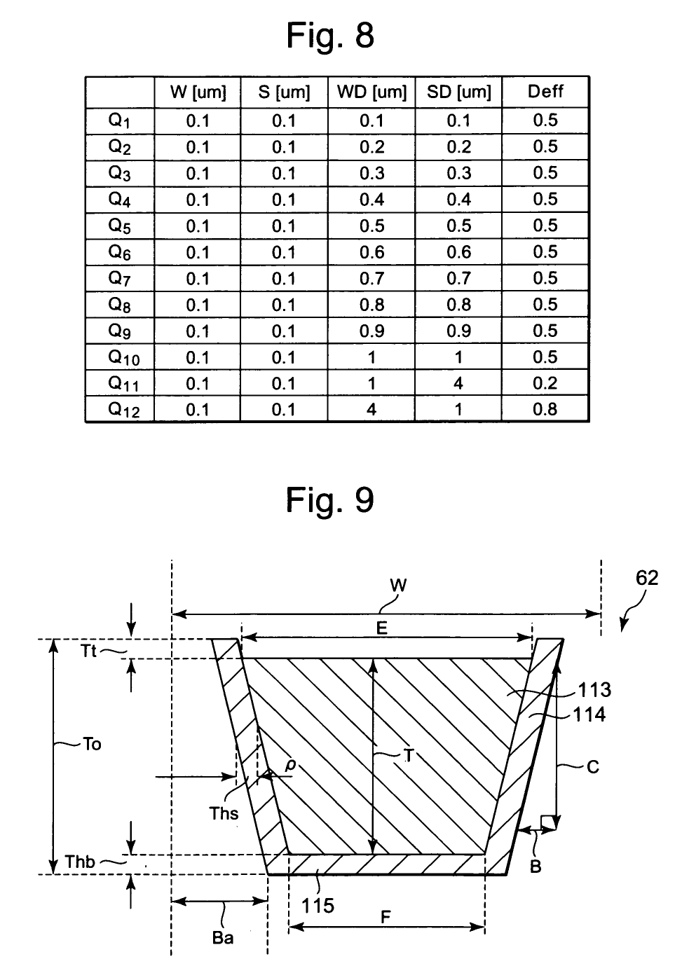

The wiring resistance data table 21 stores a resistance value R of a subject wiring 52 which has been really measured in a TEG pattern 50 to be measured shown in FIGS. 7 and 8 (to be described later) in association with the TEG pattern 50 therein.

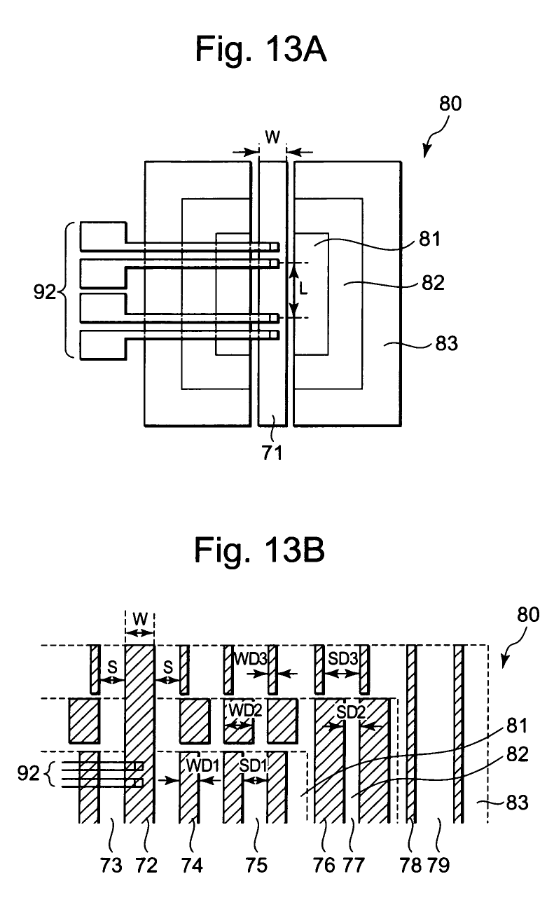

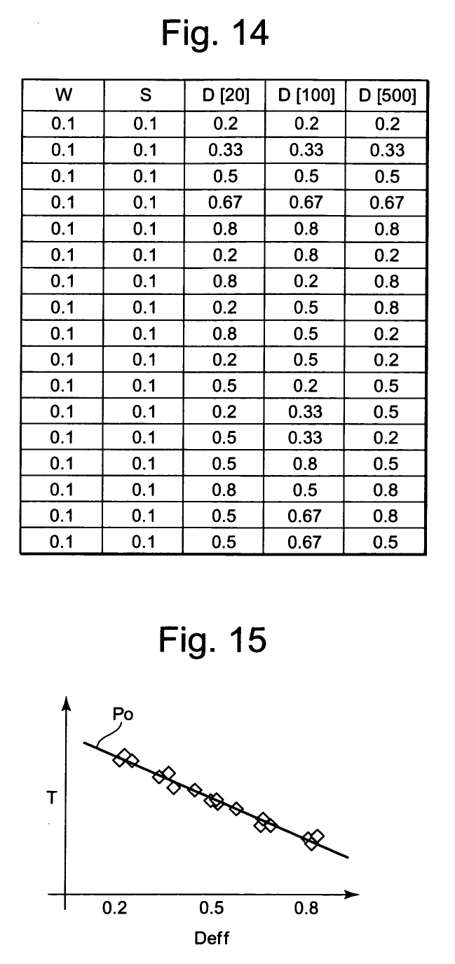

In addition, the wiring resistance data table 21 stores the resistance value R of a subject wiring 72 which has been really measured in a TEG pattern 80 to be measured as shown in FIGS. 13A, 13B and 14 (to be described later) in association with the TEG pattern 80 therein.

The layout data table 22 stores the designed values (layout dimension: FIG. 8: wiring width W of the subject wiring 52, wiring interval S, wiring width WD of peripheral wirings 54, peripheral wiring intervals SD, wiring data ratio Deff) of the TEG pattern 50 to be measured as shown in FIGS. 7 and 8 (to be described later) in association with the TEG pattern 50 therein.

Further, the layout data table 22 stores the designed values (layout dimension: FIG. 14: wiring width W of the subject wiring 72, wiring interval S, wiring widths WD1, WD2, and WD3 of peripheral wirings 74,76, and 78, peripheral wiring intervals SD1, SD2, and SD3, and wiring data ratios D1, D2, and D3) of the TEG pattern 80 as shown in FIGS. 13A, 13B and 14 (to be described later) in association with the TEG pattern 80 therein.

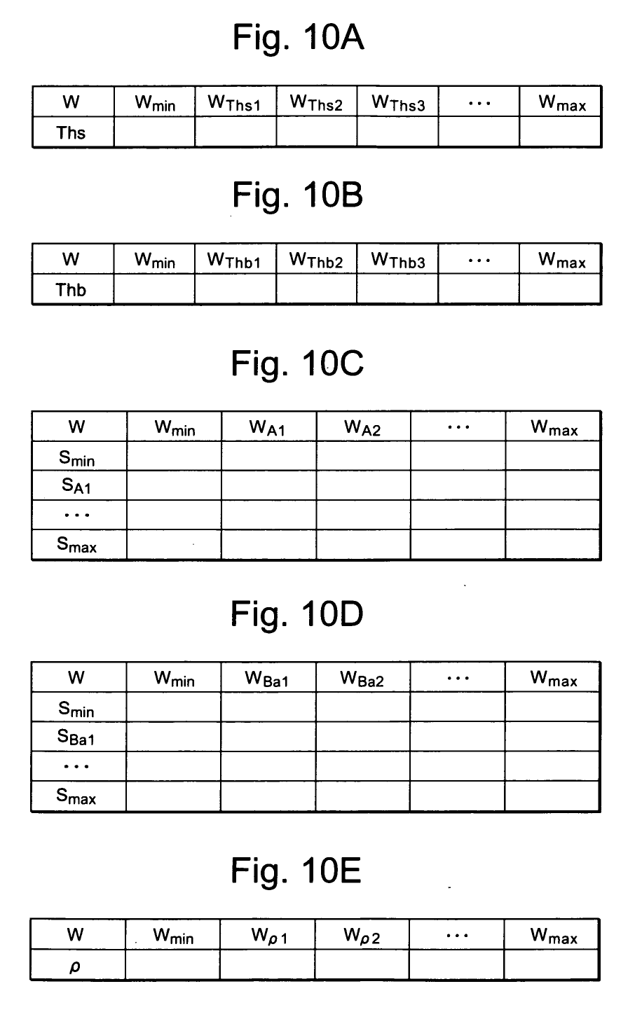

The wiring model table a 23 stores the thickness (bottom surface) Ths of a sub metal 114 which will be shown in FIG. 9 (to be described later), the thickness (side surface) Thb of the sub metal 115, a slope A of the side surface, a narrowed amount Ba of the wiring width at the bottom surface side, and the resistivity ρ of a core metal 113 in association with the wiring width W (designed value) and the wiring interval S (designed value) of the wiring therein (FIGS. 10A to 10E, to be described later).

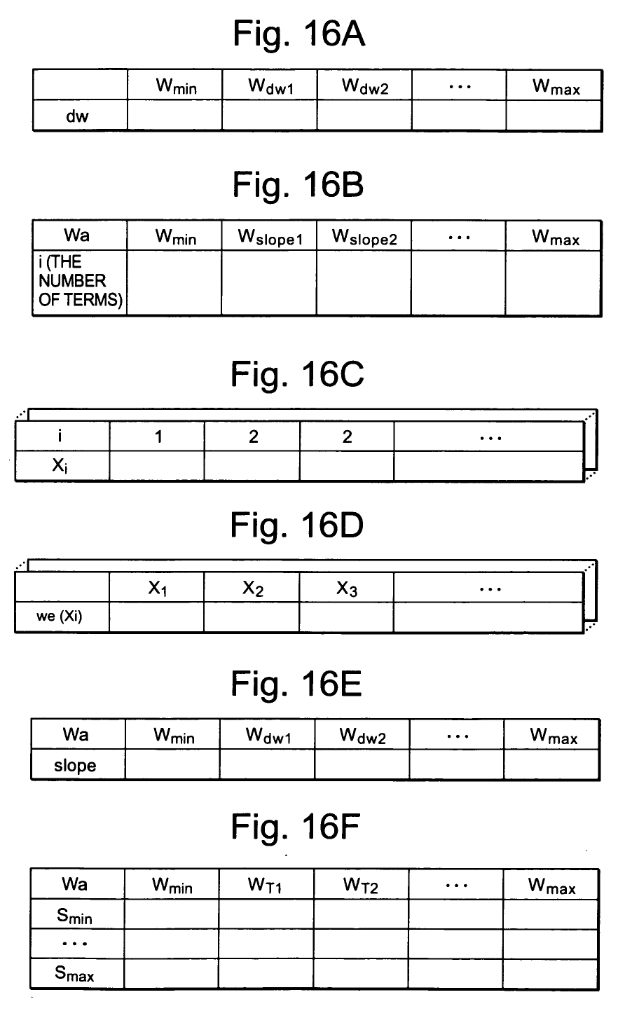

The wiring model table b 24 stores the correction value dw calculated on the basis of the TEG pattern 50 shown in FIGS. 7 and 8 (to be described later) in association with the wiring width W therein (FIG. 16A: to be described later). In addition, the wiring model table b 24 stores the number of terms i, a region Xi (i=1, 2, . . . ), a weighting coefficient we(Xi) (i=1, 2, . . . ), a slop “Slope”, and a wiring film thickness T05 at the wiring data ratio Deff=0.5, which have been calculated on the basis of the TEG pattern 80 shown in FIGS. 13A, 13B and 14 (to be described later) in association with the wiring width Wa after correction (and the wiring interval Sa after correction) therein (FIGS. 6B to 16F: to be described later).

The wiring film thickness calculation unit 11 calculates the wiring film thickness T of the subject wiring 52 of the TEG pattern 50 on the basis of the resistance value R (measured value) of the subject wiring 52 in the TEG pattern 50 stored in the wiring resistance data table 21, the wiring width W (designed value) of the subject wiring 52 in the TEG pattern 50 stored in the layout data table 22, and the thickness Ths of the sub metal 114, the thickness Thb of the sub metal 115, the slope A of the side surface, and the narrowed amount Ba of the wiring width on the bottom surface side, and the resistivity ρ of the core metal 113, which are stored in the wiring model table a 23. A specific calculating method will be described later.

Also, the wiring film thickness calculation unit 11 calculates the wiring film thickness T of the subject wiring 52 of the TEG pattern 50 on the basis of the resistance value R (measured value) of the subject wiring 72 in the TEG pattern 80 stored in the wiring resistance data table 21, the wiring width W (designed value) of the subject wiring 72 in the TEG pattern 80 stored in the layout data table 22, and the thickness Ths of the sub metal 114, the thickness Thb of the sub metal 115, the slope A of the side surface, and the narrowed amount Ba of the wiring width on the bottom surface side, and the resistivity ρ of the core metal 113, which are stored in the wiring model table a 23. A specific calculating method will be described later.

The wiring data ratio calculation unit 12 calculates the wiring data ratio Deff on the basis of the wiring width WD (designed value) and the wiring interval SD (designed value) of the peripheral wirings 54 in the TEG pattern 50 stored in the layout data table 22 (wiring data ratio Deff in FIG. 8). A specific calculating method will be described later.

The correction calculation unit 13 corrects the wiring data ratio Deff on the basis of a relationship between the wiring film thickness T calculated in the wiring film thickness calculation unit 11 and the wiring data ratio Deff calculated in the wiring data ratio calculation unit 12, to thereby calculate an appropriate correction value dw. A specific calculating method will be described later.

The correction wiring data ratio calculation unit 14 calculates the wiring data ratios D1, D2, and D3 on the basis of the corrected value dw calculated in the correction calculation unit 13, and the wiring width W of the subject wiring 72, the wiring interval S, the wiring widths WD1, WD2, and WD3 (designed values) of the peripheral wirings 74, 76, and 78, and the peripheral wiring intervals SD1, SD2, and SD3 (designed values) in the TEG pattern 80 which are stored in the layout data table 22 (exemplification: wiring data ratios D(20), D(100), and D(500) in FIG. 14). A specific calculating method will be described later.

The wiring model parameter calculation unit 15 calculates the number of terms i, the region Xi (the size of one side) (i=1, 2, . . . ), the weighting coefficient we(Xi) (i=1,2, . . . ), the slop “Slope”, and the film thickness T05 on the basis of the wiring film thickness T calculated by the wiring film thickness calculation unit 11, and a pair of the plurality of regions and the plurality of wiring data ratios D which are extracted by the correction wiring data ratio calculation unit 14. A specific calculating method will be described later.

The wiring model table generation unit 16 stores the correction value dw in association with the wiring width W (designed value) in the wiring model table b 24. Also, the wiring model table generation unit 16 stores the number of terms i, the region Xi (the size of one side), the weighting coefficient we(Xi) (i=1, 2, . . . ), the slop “Slope”, and the film thickness T05, respectively, on the basis of the in association with the corrected wiring width Wa(=W+2×dw) (and the wiring interval Sa(=S−2×dw)) in the wiring model table b 24.

Subsequently, a description will be given of a wiring model library constructing method (the operation of the wiring model library constructing device) according to an exemplary embodiment of the present invention.

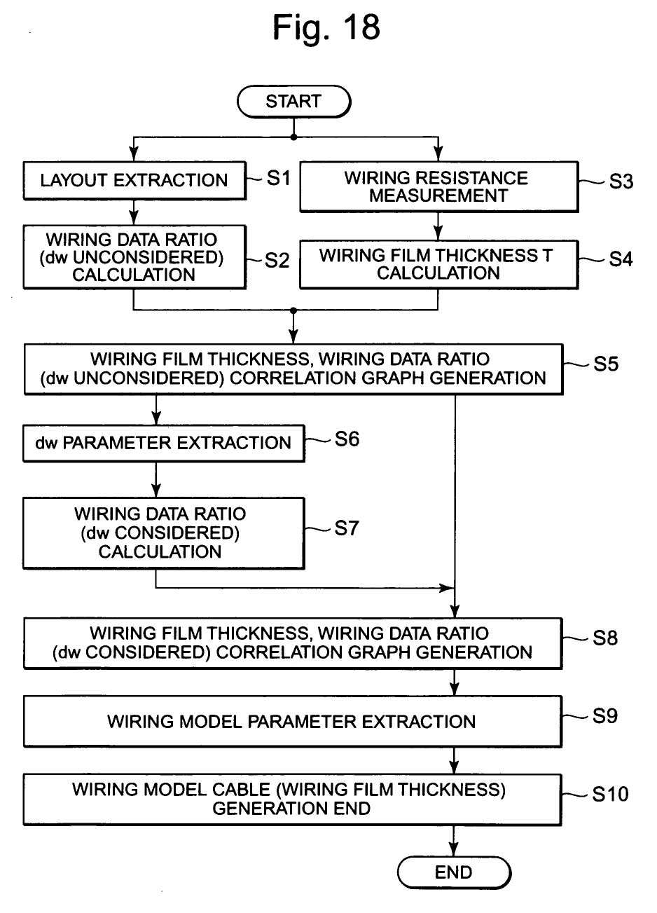

FIG. 18 is a flowchart showing the wiring model library constructing method according to the exemplary embodiment of the present invention. Hereinafter, (A) Steps S1 to Step S6, (B) Steps S7 to Step S9, and (C) Step S10 will be separately described.

(A) Extraction of Dimension of Correction Value dw (Calculation)

First, a description will be given of a method of analytically extracting (calculating) the dimension of the correction value dw (Step S1 to Step S6). In this exemplary embodiment, the dimension of dw is analytically extracted (calculated) by using the TEG (test element group) pattern 50.

(A-1) TEG Pattern 50

FIG. 7 is a top view showing the TEG pattern for de extraction in the exemplary embodiment of the present invention. The TEG pattern 50 includes the (subject) wiring 52 in question, and the plurality of (peripheral) wirings 54 disposed on both sides of the wiring 52. It is assumed that the wiring width of the wiring 52 is W, an interval of from the wiring 52 to the adjacent wirings 54 is S, the wiring width of the wirings 54 spread around the wiring 52 is WD, and the wiring interval of the wirings 54 is SD. As a region in which the wirings 54 are spread around the wiring 52, sufficiently large X and Y that cover a range affected by the subject wiring portion 51 in the subject wiring 52 are set. Symbols W, S, WD, and SD are designed values which are wiring widths and wiring intervals at the film thickness=T in FIG. 4. Also, the subject wiring portion 51 is a portion of a length L within the subject wiring 52, and the resistance value R is measured by a resistance measurement pad 90 through a four-proved method. The respective wirings are separated by interlayer insulation layers 53 and 55.

FIG. 8 is a table showing a standard example of the TEG pattern in FIG. 7. The wiring width WD and the wiring interval SD of the wirings 54 that are spread therearound which determine the wiring data ratio are allocated on the basis of the standard of FIG. 8 so that the wiring data ratio becomes 0.5. In this case, the TEG pattern 50 in which the wiring width WD and the wiring interval SD are of the size of 0.1 μm is set in a range of 0.1 to 1 μm (Q1 to Q10). In addition, the TEG pattern 50 satisfying Deff=0.2 and Deff=0.8 which is formed with WD that is a wiring width allowed under the design standard, and as thick as possible is set (Q11, Q12). In this case, the minimum and maximum wiring data ratios Deff which are allowed by the standards of the wiring data ratio are selected. In this case, Deff=0.2 is minimum wiring data ratio, and Deff=0.8 is maximum wiring data ratio.

(A-2) Calculation of Wiring Data Ratio

Subsequently, the calculation formula of the wiring data ratio will be described. In the TEG pattern 50 shown in FIGS. 7 and 8, the same wiring widths WD and the same wiring intervals SD are uniformly repeated. For that reason, the subject wiring 52 and the subject wiring portion 51 is not effective against the wiring data ratio Deff, and the wiring data ratio Deff is determined by only the wirings 54 spread therearound. Then, in the TEG pattern 50, the wiring data ratio Deff calculated through Expression (3) is a value calculated through Expression (5) not depending on how to take the number of terms I, the region Xi, and the weighting coefficient we(Xi). That is, the wiring data ratio Deff in Expression (3) can be approximated by the following Expression (5).

Deff=WD/(WD+SD) (5)

The wiring data ratio Deff to the TEG pattern 50 obtained in Expression (5) is a value obtained from the designed value (the wiring width and the wiring interval at wiring film thickness=T2) as has been described above. Accordingly, correction is conducted by the correction value dw represented by the above Expression (4) to extract (calculate) the effective wiring data ratio. That is, the effective wiring data ratio can be obtained by the following expression (6) in which the wiring width WD and the wiring interval SD are corrected with dw. The effective wiring data ratio Deff in the CMP process can be realized by using the wiring width WD+2×dw and the wiring interval SD−2×dw of the peripheral wirings 54.

Deff=(WD+2×dw)/(WD+2×dw+SD−2×dw) (6)

where the correction value dw may be defined as a function of the wiring width WD and the wiring interval SD as will be described later.

(A-3) Details of Extraction (Calculation) of Dimension of Correction Value dw (Steps S1 to S6)

Subsequently, a description will be given of a method of extracting (calculating) the dimension of the correction value dw. In this exemplary embodiment, the correction value dw that determines the wiring configuration at the time of completing the CMP process is not physically dimensionally measured by a cross-section TEM photograph, but is analytically deviated from a relationship between the wiring film thickness T and the effective wiring data ratio Deff in the CMP process.

(1) Step S1

Referring to FIG. 18, the wiring data ratio calculation unit 12 first calculates the normal wiring data ratio Deff.

That is, the wiring data ratio calculation unit 12 extracts the wiring width WD and the wiring interval SD in each of the plural TEG patterns 50 from the layout data table 22 (the designed value shown in FIG. 8).

(2) Step S2

Subsequently, the wiring data ratio calculation unit 12 substitutes the extracted wiring width WD and wiring interval SD for the above Expression (5) to calculate the wiring data ratio Deff in each of the plural TEG patterns. With the above operation, the wiring data ratio Deff is calculated in each of the plural TEG patterns 50. In this exemplary embodiment, the wiring data ratio Deff is shown in FIG. 8.

(3) Step S3

Subsequently, the wiring film thickness calculation unit 11 calculates the wiring film thickness T. The wiring film thickness T is calculated on the basis of a method disclosed in JP-A No. 2003-108622.

First, in calculation of the wiring film thickness T, the resistance value R of the subject wiring portion 51 of the subject wiring 52 is measured in each of the plural TEG patterns 50. The measured resistance value R is stored in the wiring resistance data table 21 in association with the TEG pattern 50. The wiring film thickness calculation unit 11 extracts the resistance value R of the subject wiring 52 from the wiring resistance data table 21 in each of the plural TEG patterns 50.

(4) Step S4

Subsequently, the wiring film thickness calculation unit 11 calculates the wiring film thickness T by using Expression (8) that will be described later on the basis of the extracted resistance value R and the data extracted from the layout data table 22 and the wiring model table a 22. Expression (8) will be described in detail below.

The Expression (8) calculating the wiring film thickness T is derived as follows (based on a method disclosed in JP-A No. 2003-108622). FIG. 9 is a cross-sectional view showing the wiring after the CMP process has been completed. The wiring 62 includes a core metal 113 in the center thereof, a sub metal 114 that covers the side surfaces of the core metal 113, and a sub metal 115 that covers the bottom surface thereof. The respective parameters are represented as follows.
W: a designed value of the wiring width
Ba: narrowed amount of the width on the bottom surface side
T: a thickness of the core metal 113
E: a length of an upper base of trapezoid of the core metal 113
Ths: a thickness of the sub metal 114
T0: a thickness of the wiring including the sub metal 114
A (=B/C): a slope of the side surface
ρ: a resistivity of the core metal 113
F: a length of a lower base of trapezoid of the core metal 113
Thb: a thickness of the sub metal 115
Tt: a projection thickness of the sub metal 114

The wiring width W (designed value) may be a width at any position in a depth direction in the real wiring 62. That is, the wiring width W may be a width at a position of the wiring film thickness T, or a width at a position of the wiring film thickness T2. This is because a variation in the wiring width W at those positions is reflected by the narrowed amount Ba of the width on the bottom surface side from a relationship of the wiring width W and the narrowed amount Ba of the width on the bottom surface side.

The cross section of the wiring 62 is trapezoidal as shown in FIG. 9. Accordingly, the cross-sectional area Sx can be represented by the following Expression (7) through the following calculation.

Sx=(E+F)×T/2: Formula of an area of trapezoid

E=W−2×(Ba+Ths−A×Thb)

F=E+(2×A×T)

Sx=(2×(W−2×(Ba+Ths−A×Thb))+(2×A×T))×T/2=(W−2×Ba−2×Ths+2×A×Thb+A×T)×T (7)

Consider that the resistance value R of the wiring 62 is substantially determined according to the resistivity ρ of the core metal 113 assuming that the length of the wiring 62 is L, and the resistance value (measured value) is R. Then, the wiring film thickness of the core metal 113 can be represented by the following Expression (8) through the following calculation using a relationship of ρ=R×Sx/L and the following expression using Expression (7).

ρ=R×(W−2×Ba−2×Ths+2×A×Thb+A×T)×T/L

T is resolved in the expression to obtain the following solution.

T=(−R×b±(r2×b2−4×R×A×(−ρ×L))^{0.5})/2×R×A (8)

where b=(W−2×Ba−2×Ths+2×A×Thb)

In this case, the narrowed amount Ba of the wiring width on the bottom surface side, the thickness Ths of the sub metal 114, the thickness Thb of the sub metal 115, the slope A of the side surface, and the resistivity ρ of the core metal 113 can be obtained on the basis of the wiring width W with reference to the wiring model table a23. FIGS. 10A to 10E are tables showing the wiring model table a according to the exemplary embodiment of the present invention. The calculating method for the wiring model table a 23 is calculated, by the method described in JP-A No. 2003-108622, as a function of the wiring width W (designed value) of the TEG pattern as shown in FIGS. 10A to 10E.

FIG. 10A shows a relationship between the wiring width W (wiring width W of the subject wiring in the TEG pattern) and the thickness Ths of the sub metal 114. The thickness Ths of the sub metal 114 can be obtained with reference to the contents of FIG. 10A in the wiring model table a on the basis of the wiring width W. In the case where there is no corresponding wiring width W, the thickness Ths of the sub metal 114 is obtained through extrapolation or interpolation.

FIG. 10B shows a relationship between the wiring width W (wiring width W of the TEG pattern subject wiring) and the thickness Thb of the sub metal 115. The thickness Thb of the sub metal 115 can be obtained on the basis of the wiring width W with reference to the contents of the wiring model table a in FIG. 10B. In the case where there is no corresponding wiring width W, the thickness Thb of the sub metal 115 is obtained through extrapolation or interpolation.

FIG. 10C shows a relationship between the wiring width W (wiring width W and wiring interval S of the TEG pattern subject wiring) and the narrowed amount Ba of the wiring width on the bottom surface side. The slope A of the side surface can be obtained on the basis of the wiring width W and the wiring interval S with reference to the contents of the wiring model table a in FIG. 10C. In the case where there is no corresponding wiring width W and wiring interval S, the slope A of the side surface is obtained through extrapolation or interpolation.

FIG. 10D shows a relationship between the wiring width W, the wiring interval S (the wiring width W and the wiring interval S of the TEG pattern subject wiring), and the narrowed amount Ba of the wiring width on the bottom surface side. The narrowed amount Ba of the wiring width on the bottom surface side can be obtained on the basis of the wiring width W and the wiring interval S with reference to the contents of the wiring model table a in FIG. 10D. In the case where there is no corresponding wiring width W and wiring interval S, the narrowed amount Ba of the wiring width on the bottom surface side is obtained through extrapolation or interpolation.

FIG. 10E shows a relationship between the wiring width W (the wiring width W of the TEG pattern subject wiring), and the resistivity ρ of the core metal 113. The resistivity ρ of the core metal 113 can be obtained on the basis of the wiring width W with reference to the contents of the wiring model table a in FIG. 10E. In the case where there is no corresponding wiring width W and wiring interval S, the resistivity ρ of the core metal 113 is obtained through extrapolation or interpolation.

The narrowed amount Ba of the wiring width on the bottom surface side, the thickness Ths of the sub metal 114, the thickness Thb of the sub metal 115, the slope A of the side surface, the resistivity ρ, the resistance value R being a real value, the wiring width W being a designed value, and the wiring length L which are obtained on the basis of the wiring width W with reference to the wiring model table a 23 are substituted for the above Expression (8). Then, the film thickness T of the core metal 113, that is, the wiring film thickness T of the substantial wiring can be obtained. In this way, the wiring film thickness T of the respective subject wirings 52 can be extracted (calculated) in the plurality of TEG patterns 50, respectively.

(5) Step S5

The correction calculation unit 13 then extracts (calculates) dw being a corrected value with reference to FIG. 18.

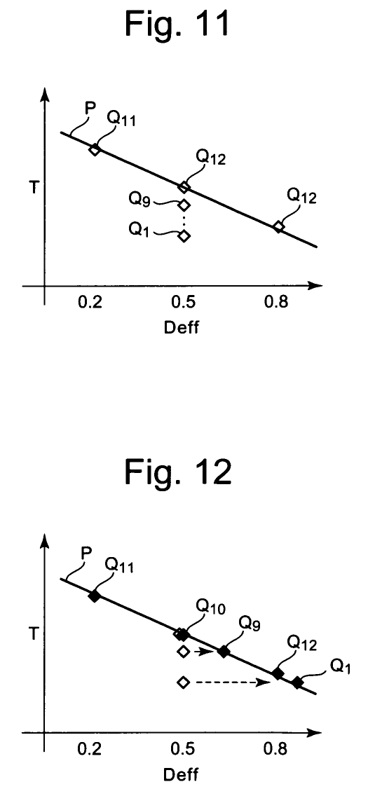

That is, the correction calculation unit 13 obtains a function of the wiring film thicknesses T extracted from the plurality of TEG patterns 50 in Steps S03 and S04, and the wiring data ratio Deff calculated in Steps S01 and S02. FIG. 11 is a graph showing a relationship between the wiring film thickness T and the wiring data ratio Deff. The axis of ordinate is the wiring film thickness T, and the axis of abscissa is the wiring data ratio Deff. The respective points (Q1 to Q12) correspond to the TEG patterns Q1 to Q12 of FIG. 8.

Consider that the wiring data ratio Deff is constant (exemplification: Deff=0.5). The TEG pattern 50 (exemplification: Q1) in which the wiring width WD of the peripheral wirings is small, that is, a large number of thin wirings are spread is greatly affected by the correction value dw. As is understood from Expression (6) of the effective data ratio, this is because the effect of the correction value dw with respect to the wiring data ratio Deff is larger as both of the wiring width WD and the wiring interval SD are smaller. For that reason, the effective wiring data ratio in the CMP process is larger than the wiring data ratio (Expression (5)) not taking dw in consideration. The real wiring film thickness T is thinner as the effective wiring data ratio is larger. On the other hand, the TEG pattern 50 (exemplification: Q10) in which the wiring width WD of the peripheral wirings is large, and the wiring interval SD of the peripheral wirings is large is small in the influence of the correction value dw. As is understood from Expression (6) of the effective data ratio, this is because the effect of the correction value dw with respect to the wiring data ratio Deff is smaller as both of the wiring width WD and the wiring interval SD are larger. For that reason, the effective wiring data ratio in the CMP process hardly differs from the wiring data ratio (Expression (5)) not taking dw in consideration.

On the other hand, consider that the wiring data ratio Deff is different (exemplification: 0.2, 0.8). The TEG pattern 50 (exemplification: Q11, Q12) which is formed with WD of the maximum width on the design standard is smaller in the influence of the correction value dw as both of the wiring width WD and the wiring interval SD are larger. For that reason, the effective wiring data ratio in the CMP process hardly differs from the wiring data ratio (Expression (5)) not taking dw in consideration.

It is possible to consider that the graph (and the slope of the graph) of the straight line P indicative of the wiring film thickness T to the wiring data ratio Deff shown in the TEG pattern in which the wiring width WD of the peripheral wirings is large, and the wiring interval SD of the peripheral wirings is large, or in the TEG pattern 50 (exemplification: Q11, A12) which is formed with the wiring width WD of the maximum width on the design standard is “physical ideal line”.

(6) Step S6

Subsequently, the correction calculation unit 13 sets a temporary value of the correction value dw. Then, the wiring data ratio Deff is replaced with the wiring data ratio Deff calculated through the above Expression (6) as the effective wiring data ratio calculating method in the CMP process. FIG. 12 is a graph showing a relationship between the wiring film thickness T and the effective wiring data ratio Deff. The axis of ordinate is the wiring film thickness T, and the axis of abscissa is the wiring data ratio Deff calculated in Expression (6). The respective points (Q1 to Q12) correspond to Q1 to Q12 of the TEG pattern 50 in FIG. 8. In this case, the temporary value of the correction value dw appropriately changes. Then, the value of the correction value dw is determined so that another measured point (exemplification: Q1 to Q9) are put on a physical ideal line (straight line P) drawn by using the TEG pattern 50 (exemplification: Q10, Q11, Q12) in which the wiring width WD of the peripheral wirings is large. That is, the value of the correction value dw is determined so that a relationship between the wiring film thickness T and the effective wiring data ratio Deff becomes linear.

As shown in the figure, the TEG pattern 50 (exemplification: Q1) small in the wiring width WD of the peripheral wirings is largely affected by the correction value dw. For that reason, as compared with a case of FIG. 11, the position varies in the right direction of the graph. However, the TEG pattern 50 (exemplification: Q10, Q11, Q12) large in the wiring width WD of the peripheral wirings is hardly affected by the correction value dw. For that reason, its position does not vary as compared with the case of FIG. 11. In this way, the correction value dw can be determined.

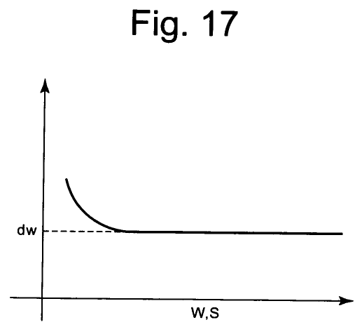

In this case, when a point is not put on the physical ideal line (straight line P) unless the correction value dw is defined for each of the designed values of the wiring width WD of the peripheral wirings, the correction value dw can be expressed by a function of the wiring width WD of the peripheral wirings. FIG. 17 is a graph showing a relationship between the correction value dw and the wiring width WD (or the wiring interval SD) of the peripheral wirings. The axis of ordinate is the correction value dw, and the axis of abscissa is the wiring width WD (or the wiring interval SD). As usual, the correction value dw is a constant value. However, as shown in the figure, in particular, there is a possibility that the wiring width WD (or the wiring interval SD) dependency of the correction value dw is larger as the wiring width WD (or the wiring interval SD) is smaller. In that case, a point is not put on the physical ideal line (straight line P) when the correction value dw of a constant value is used. Accordingly, in that case, the correction value dw is expressed by the function of the wiring width WD (or the wiring interval SD) of the peripheral wirings. Alternatively, a portion where there is no measured point may be expressed by linear complement with provision of a table representing a relationship between the correction value dw and the wiring width WD.

(B) Extraction (Calculation) of Parameters (i, Xi, we(Xi), Slop, T05) of Wiring Model

Subsequently, a description will be given of a method of extracting (calculating) the number of terms i, the region Xi (the size of one side), the weighting coefficient we(Xi), the slop “Slope”, and the film thickness T05 (Steps S7 to S9). In this exemplary embodiment, the parameters of the wiring model are analytically extracted (calculated) by the aid of the TEG pattern 80.

(B-1) TEG Pattern 80

FIG. 13A is a top view showing the TEG pattern for wiring model parameter extraction according to the exemplary embodiment of the present invention. The TEG pattern 80 includes the subject wiring 72, the region 81 whose wiring data ratio is D1, the region 82 whose wiring data ratio is D2, and the region 83 whose wiring data ratio is D3. That is, the TEG pattern 80 is divided into three kinds of regions 81 to 83 whose one side is Xi centered on the subject wiring 71. Then, in the respective regions 81 to 83, the wirings are spread with dimensions under the design standard so as to provide several wiring data ratios D1 to D3.

FIG. 13B is a partial top view showing the TEG pattern for wiring model parameter extraction according to the exemplary embodiment of the present invention. In the TEG pattern 80, specifically, it is assumed that the wiring width of the wiring 72 is W, and an interval of from the wiring 72 to the adjacent wirings 74 is S. The region 81 has wirings 74 (wiring width WD1, wiring interval SD1) which are disposed on both sides of the wiring 72 and spread around the wiring 72. The region 82 has wirings 76 (wiring width WD2, wiring interval SD2) which are disposed on both sides of the wiring 72 so as to surround the region 81, and spread around the wiring 72 and the region 81. The region 83 has wirings 78 (wiring width WD3, wiring interval SD3) which are disposed on both sides of the wiring 72 so as to surround the region 82, and spread around the wiring 72 and the region 82. The number of divisions of one side Xi of the region may be set to any number. The kind of wiring data ratio D on the standard may be also set to any number. The respective wirings are isolated by interlayer insulation layers 73, 75, 77, and 79.

FIG. 14 is a table showing a standard example of the TEG pattern in FIGS. 13A and 13B. In this case, there is shown an example in which the wiring width W/wiring interval S of the subject wiring 72 is 0.1/0.1, the region 81 is in a range of 20 μm×20 μm, the region 82 is in a range of 100 μm×100 μm except for the region 81, and the region 83 is in a range of 500 μm×500 μm except for the regions 81 and 82. In this case, each of the regions 81 to 83 has a wiring of the same wiring width spread at the same wiring intervals. That is, in the region 81, the wirings 74 each with the wiring width WD1 are spread at the same wiring interval SD1. Likewise, in the region 82, the wirings 76 each with the wiring width WD2 are spread at the same wiring interval SD2, and in the region 83, the wirings 78 each with the wiring width WD3 are spread at the same wiring interval SD3. When the W/S of the wiring 72 is set to other dimensions, it is necessary to produce the TEG pattern and implement the standardization as in the case of FIG. 14.

(B-2) Calculation of Wiring Data Ratio

Subsequently, the calculation formula of the wiring data ratio will be described. In the TEG pattern 80 shown in FIGS. 13A, 13B, and 14, the respective wiring data ratios D of the regions 81 to 83 can be calculated by the following Expression (9).

D(20)=(WD1×2×dw)/(WD1+2×dw+SD1−2×dw)

D(100)=(WD2×2×dw)/(WD2+2×dw+SD2−2×dw)

D(500)=(WD3×2×dw)/(WD1+2×dw+SD3−2×dw) (9)

In the above Expression (9), the respective wiring data ratios D of the entire region 81, the entire region 82, and the entire region 83 are obtained. However, in one TEG pattern 80, the setting of the region whose wiring data ratio D is obtained is not limited to the above regions 81 to 83. That is, in the case where it is assumed that a region is divided into three pieces, when one sides of the regions are Xa1, Xa2, and Xa3, respectively, the ranges of Xa1, Xa2, and Xa3 can be set to arbitrary ranges satisfying 0<Xa1<Xa2<Xa3. An upper limit can be arbitrarily set even to 500 μm or more. In that case, the calculating method of D(Xa) is stated as follows, for example, in the case where Xa1<20 μm, 20 μm<Xa2<100 μm, and 100 μm<Xa3<500 μm.

D(Xa1)=(WD1+2×dw)/(WD1+2×dw+SD1−2×dw)

D(Xa2)=α1×(WD1+2×dw)/(WD1+2×dw+SD1−2×dw)+α2×(WD2+2×dw)/(WD2+2×dw+SD2−2×dw)

D(Xa3)=β1×(WD2+2×dw)/(WD2+2×dw+SD2−2×dw)+β2(WD3+2×dw)/(WD3+2×dw+SD3−2×dw) (9′)

where α1 and α2 is a ratio of an area included in the region 81 to an area included in the region 82 in the second region, and α1+α2=1. Likewise, β1 and β2 is a ratio of an area included in the region 82 to an area included in the region 83 in the third region, and β1+β2=1. Also, in the above case, the region is divided into three pieces, but can be divided into three or more pieces.

(B-3) Details of Extraction (Calculation) of Parameters (i, Xi, we(Xi), Slope, T05) of the Wiring Model (Steps S7 to S9)

Subsequently, a method of extracting (calculating) the parameter of the wiring model will be described. In this exemplary embodiment, the parameter of the wiring model is analytically derived by a relationship of the wiring film thickness T and the effective wiring data ratio Deff in the CMP process.

(1) Step S7

Referring to FIG. 18, the correction wiring data ratio calculation unit 14 first sets the number of terms i which is the number of regions (exemplification: i=3), and the region (exemplification: [20 μm, 100 μm, 500 μm], [Xa1, Xa2, Xa3], [ . . . ], . . . ), as temporary values in the respective TEG patterns 80. Then, the correction wiring data ratio calculation unit 14 calculates the wiring data ratios D(20), D(100), D(500), D(Xa1), D(Xa2), D(Xa3), . . . in the respective regions through Expression (9) and Expression (9′) on the basis of the set region, the corrected value dw calculated in the correction calculation unit 13, and the wiring widths WD1, WD2, and WD3, and the peripheral wiring intervals SD1, SD2, and SD3 (designed values) of the peripheral wirings 74, 76 and 78 in the TEG pattern 80 which are stored in the layout data table 22.

In this way, plural pairs of plural regions and plural data wiring ratios D can be obtained by how to take the number of terms i (exemplification: i=3), and the region (exemplification: [20 μm, 100 μm, 500 μm], [Xa1, Xa2, Xa3], [ . . . ], . . . ). The pair of plural regions and plural wiring data ratios is, for example, a pair of region [20, 100, 500] and wiring data ratios [D(20), D(100), D(500)], or a pair of region [Xa1, Xa2, Xa3] and wiring data ratios [D(Xa1), D(Xa2), D(Xa3)].

(2) Step S8

On the other hand, the wiring film thickness T of the wiring 72 in the respective TEG patterns in FIG. 14 can be calculated as in Steps S3 and S4. That is, first, in calculation of the wiring film thickness T, in each of the plural TEG patterns 80, the resistance value R of the subject wiring portion of the subject wiring 72 is measured. The measured resistance value R is stored in the wiring resistance data table 21 in association with the TEG pattern 80. Then, the wiring film thickness calculation unit 11 extracts the resistance value R of the subject wiring 72 in each of the plural TEG patterns 80 from the wiring resistance data table 21. Subsequently, the wiring film thickness calculation unit 11 is capable of calculating the wiring film thickness T through Expression (8) according to the narrowed amount Ba of the wiring width on the bottom surface side, the thickness Ths of the sub metal 114, the thickness Thb of the sub metal 115, the slope A of the side surface, and the resistivity ρ of the core metal 113, which are obtained on the basis of the wiring width W with reference to the wiring width W of the wiring 72 (designed value), the wiring length L (designed value), the resistance value R (real value), and the wiring model table. That is, one wiring film thickness T is extracted from one TEG pattern 80.

Subsequently, the wiring model parameter calculation unit 15 sets a temporary value of the weighting coefficient We(Xi) to the respective set regions Xi. Then, the wiring model parameter calculation unit 15 obtains a relationship between the wiring data ratio Deff calculated through Expression (2) and the wiring film thickness T on the basis of the plural pairs of plural regions Xi and plural data wiring ratios Deff which are calculated from each of the plural TEG patterns 80 shown in FIG. 14, and the wiring film thickness T, by using the temporary value of the weighting coefficient We(Xi). FIG. 15 is a graph showing a relationship between the wiring film thickness T and the wiring data ratio Deff. The axis of ordinate is the wiring film thickness T, and the axis of abscissa is the wiring data ratio Deff calculated through Expression (2).

(3) Step S9

The wiring model parameter calculation unit 15 appropriately changes the number of terms i, one side of the region Xi(i=1, 2, . . . ), and the weighting coefficient we(Xi)(i=1, 2, . . . ) which are parameters of the wiring data ratio Deff(Expression (2)) in the relationship of FIG. 15. Then, the number of terms i, one side of the region Xi, and the weighting coefficient we(Xi) which are parameters of the wiring data ratio Deff are determined so that the wiring film thickness T is put on one straight line (P0). That is, the number of terms i, one side of the region Xi, and the weighting coefficient we(Xi) are determined so that a relationship between the wiring data ratio Deff (Ex. (2)) and the wiring film thickness T becomes linear. The parameter Xi corresponds to one side of the region when the wiring data ratio D(Xi) is calculated in Expressions (9) and (9′). The weighting coefficient we(Xi) is a weighting coefficient when the wiring data ratio D(Xi) is added, and its total is 1.

That is, the number of terms i and one side of the region Xi are changed so that the wiring film thickness T is put on one straight line (P0), thereby changing D(Xi) due to Expressions (9) and (9′). At the same time, the weighting coefficient we(Xi) corresponding to the wiring data ratio D(Xi) is changed to calculate the wiring data ratio Deff due to Expression (2). Then, when a graph plotted as its result in FIG. 15 is put on the straight line P0, it is assumed that the straight line P0 is indicative of Expression (3). In this way, there is determined the film thickness T05 of the wiring in the case of the number of terms i, one side of the region Xi, the weighting coefficient we(Xi), the slope “Slope”, and the wiring data ratio Deff=0.5, which are parameters of the wiring model. Those determined parameters are calculated by the aid of the corrected value dw, and therefore are made high in precision as compared with a case in which the corrected value dw is not considered.

The above Steps S8 and S9 are implemented, similarly, on other TEG patterns 80 in which the wiring width W/wiring interval S of the subject wiring 72 are other dimensions.

(C) Generation of Wiring Model Table

Subsequently, a description will be given of a method of generating the wiring model table b 24 that stores the wiring model therein (Step S10).

(1) Step S10

Referring to FIG. 18, the wiring model table generation unit 16 generates the wiring model table b 24 (FIG. 16A) representative of a relationship between the wiring width W and the corrected value dw on the basis of the layout data table 22 and the corrected value dw obtained in Step S1 to S4. Also, the wiring model table generation unit 16 generates the wiring model table b 24 (FIGS. 16B to 16F) representative of a relationship between the wiring width W (and wiring interval S) and the respective parameters on the basis of the layout data table 22 and the parameters (i, Xi, we(Xi), Slope, T05) of the wiring model obtained in Steps S7 to S9. Then, the generated wiring model table b 24 (FIGS. 16A to 16F) is stored in the storage unit 17 as data included in the wiring model library.

FIGS. 16A to 16F are tables indicative of the wiring model table b according to an exemplary embodiment of the present invention.

FIG. 16A shows a relationship between the wiring width W (wiring width W (designed value) of the subject wiring in the TEG pattern 80) and the corrected value dw. The corrected value dw is a value calculated in the above Step S6. When there is no corresponding wiring width W, the corrected value dw is obtained through extrapolation or interpolation. The figure shows a case in which the corrected value dw has the wiring width W (designed value) dependency. When the corrected value dw has no wiring width W dependency, the corrected value dw is a given value (one). Referring to the contents of the wiring model table b 24 in FIG. 16A, the corrected value dw can be obtained.

FIG. 16B shows a relationship between the corrected wiring width Wa (wiring width of TEG pattern subject wiring W+2×dw) and the number of terms i. Referring to the contents of the wiring model table b 24 in FIG. 16B, the number of terms i can be obtained on the corrected wiring width Wa. When there is no corresponding wiring width Wa, the number of terms i is obtained through extrapolation or interpolation. A decimal part is rounded off.

FIG. 16C shows a relationship between the number of terms i and the region Xi (the dimension of one side). This is disposed on each of the corrected wiring widths Wa (wiring width of TEG pattern subject wiring W+2×dw). Referring to the contents of the wiring model table b 24 in FIG. 16C, the respective regions Xi (the dimension of one side) can be obtained on the basis of the corrected wiring width Wa and the number of terms i. When there is no corresponding wiring width Wa, the respective regions Xi (the dimension of one side) are obtained through extrapolation or interpolation.

FIG. 16D shows a relationship between the respective regions Xi (the dimension of one side) and the weighting coefficient we(Xi). This is disposed on each of the corrected wiring widths Wa (wiring width of TEG pattern subject wiring W+2×dw). Referring to the contents of the wiring model table b 24 in FIG. 16D, the respective weighting coefficients we(Xi) can be obtained on the basis of the corrected wiring width Wa and the respective regions Xi (the dimension of one side). When there is no corresponding wiring width Wa, the respective weighting coefficients we(Xi) are obtained through extrapolation or interpolation.

FIG. 16E shows a relationship between the corrected wiring width Wa (wiring width of TEG pattern subject wiring W+2×dw) and the slope “Slope”. Referring to the contents of the wiring model table b 24 in FIG. 16E, the slope “Slope” can be obtained on the basis of the corrected wiring width Wa. When there is no corresponding wiring width Wa, the slope “Slope” is obtained through extrapolation or interpolation.

FIG. 16F shows a relationship between the wiring width Wa as well as the wiring interval Sa (wiring width of TEG pattern subject wiring W+2×dw and the wiring interval S−2×dw), and the film thickness T05 of the wiring when the wiring data ratio Deff=0.5. Referring to the contents of the wiring model table b 24 in FIG. 16F, the film thickness T05 can be obtained on the basis of the wiring width Wa and the wiring interval Sa. When there is no corresponding wiring width Wa and no wiring interval Sa, the film thickness T05 is obtained through extrapolation or interpolation.

In the above manner, the wiring model (wiring model table) based on the corrected values of the wiring width and the wiring interval, and the effective wiring data ratio Deff obtained by the corrected wiring width and the corrected wiring interval is generated, thereby enabling the wiring model library indicative of the wiring model to be constructed.

When the CMP process is considered, an error is included in the wiring area ratio calculated from a technique in which the wiring width is not corrected. However, according to this exemplary embodiment, the effective corrected value dw value is extracted in the CM process, thereby making it possible to calculate a physically correct wiring area ratio. As a result, it is possible to cancel the model error occurring when using a technique in which the wiring width is not corrected, and to improve the precision.

Subsequently, a description will be given of a case in which the wiring model (wiring model library) which is made higher in the precision in the wiring model library constructing method is taken in the design environment LPF (layout parameter extract). In the case where the wiring model is taken in the design environment LPF, the following layout parameter extracting device and layout parameter extracting method are used. Hereinafter, a description will be given of the layout parameter extracting device and the layout parameter extracting method according to an exemplary embodiment of the present invention.

First, a description will be given of the configuration of the layout parameter extracting device according to the exemplary embodiment of the present invention.

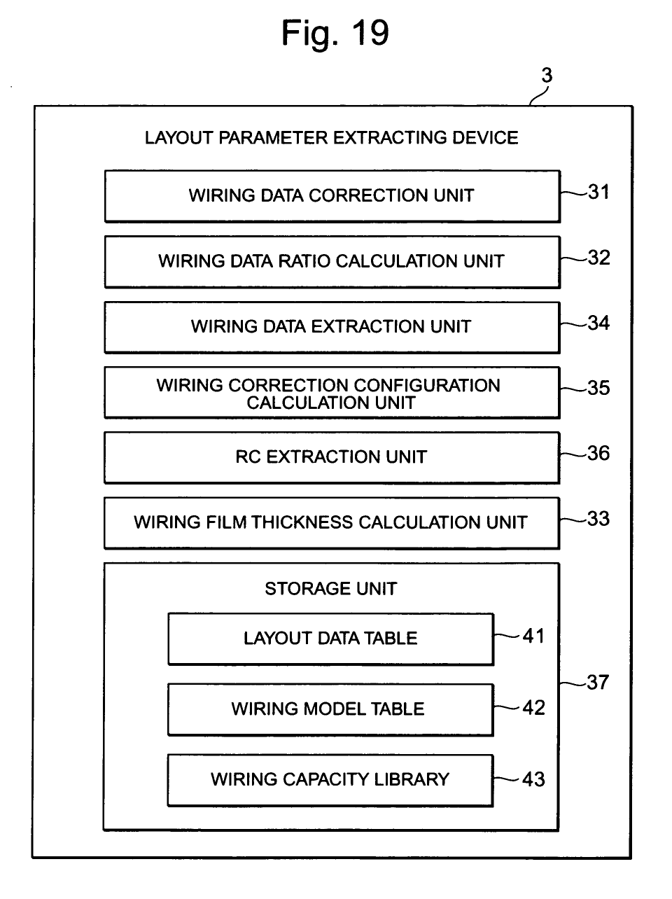

FIG. 19 is a block diagram showing the configuration of the layout parameter extracting device according to the exemplary embodiment of the present invention. A layout parameter extracting device 3 functions as the layout parameter extracting device 3 of the present invention, in which layout parameter extraction program (layout parameter extracting method) according to the present invention is installed in an information processing device exemplified by a personal computer. The layout parameter extracting device 3 includes a wiring data correction unit 31, a wiring data ratio calculation unit 32, a wiring film thickness calculation unit 33, a wiring data extraction unit 34, a wiring correction configuration calculation unit 35, an RC extraction unit 36, and a storage unit 37.

The storage unit 37 is a storage device equipped in the information processing device, which is exemplified by an HDD or a semiconductor memory. The storage unit 37 includes a layout data table 41, a wiring model table 42, and a wiring capacity library 43.

The layout data table 41 stores data (including a net list) related to the layout (designed values) of the wiring such as the positions, the wiring widths W, and the wiring intervals S of the respective wirings in the semiconductor integrate circuit to be designed therein.

The wiring model table 42 store the wiring model table a 23 and the wiring model table b 24 (wiring model library) of the wiring model library constructing device 1 therein.

The wiring capacity library 43 has wiring capacities corresponding to the wiring configurations stored therein.

The wiring data correction unit 43 determines the correction value dw on the basis of the wiring width W and the wiring interval S (designed values) of the subject wiring which are extracted from the layout library constructing device 1 with reference to the wiring model table 42 (wiring model table b 24). Then, the wiring data correction unit 43 corrects the wiring width W and the wiring interval S (designed values) to calculate the corrected wiring width Wa (=W+2×dw) and the corrected wiring interval Sa (=S−2×dw).

The wiring data ratio calculation unit 32 extracts the number of terms I, the region Xi (the dimension of one side), and the weighting coefficient we(Xi) on the basis of the corrected wiring width Wa and wiring interval Sa which are calculated by the wiring data correction unit 31 with reference to the wiring model table 42 (wiring model table b 24). Then, the wiring data ratio calculation unit 32 calculates the wiring data ratio Deff on the basis of the wiring data ratio D(Xi) and the weighting coefficient we(Xi) which are calculated from the wiring width Wa, the wiring interval Sa, the number of terms i, and the region Xi (the dimension of one side). A specific calculating method will be described later.

The wiring film thickness calculation unit 33 extracts the slope “Slope” and the film thickness T05 at the wiring data ratio Deff=0.5 on the basis of the corrected wiring width Wa and wiring interval Sa with reference to the wiring model table 42 (wiring mode table b 24). Then, the wiring film thickness calculation unit 33 calculates the wiring film thickness T on the basis of the slope “Slope” and the wiring data ratio Deff made in the wiring data ratio calculation unit 32. A specific calculating method will be described later.

The wiring data extraction unit 34 extracts the narrowed amount Ba of the wiring width on the bottom surface side, the thickness Ths of the sub metal 114, the thickness Thb of the sub metal 115, the slope A of the side surface, and the resistivity ρ of the core metal 113, on the basis of the wiring width W, the wiring interval S, and the wiring length L (designed value) which are extracted from the layout data table 41 with reference to the wiring model table 42 (wiring model table a 23).

The wiring correction configuration calculation unit 35 determines the configuration of the corrected subject wiring on the basis of the wiring film thickness T calculated by the wiring film thickness calculation unit 33, and the narrowed amount Ba of the wiring width on the bottom surface side, the thickness Ths of the sub metal 114, the thickness Thb of the sub metal 115, and the slope A of the side surface which are extracted by the wiring data extraction unit 34.

The RC extraction unit 36 calculates the wiring resistance and the wiring capacity on the basis of the configuration of the wiring determined by the wiring correction configuration calculation unit 35, the resistivity ρ of the wiring model table 42 (wiring model table a 23), the wiring capacity library 43, and the layout data table 41.

The layout parameter extracting device according to this exemplary embodiment may include the above wiring model library constructing device. In that case, the above wiring model library constructing method and a layout parameter extracting method which will be described later can be executed by one device, which is preferable.

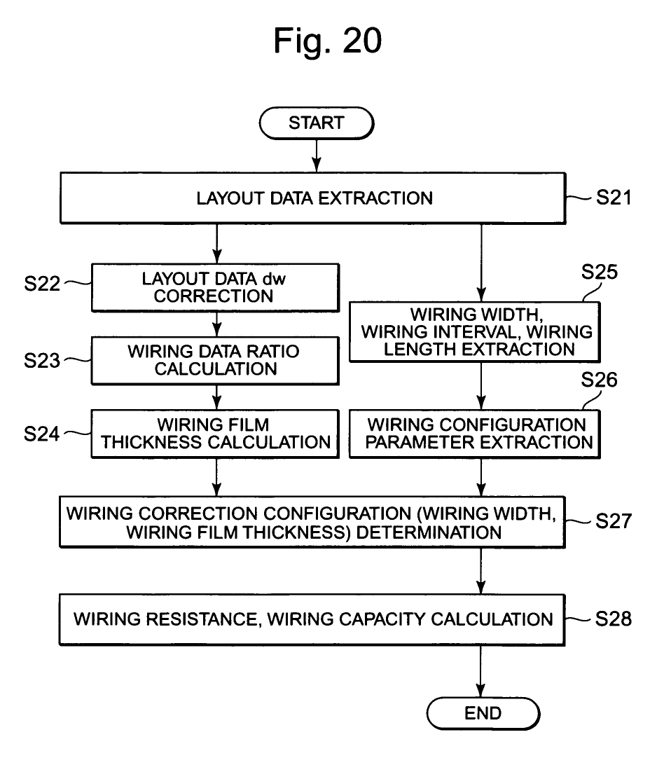

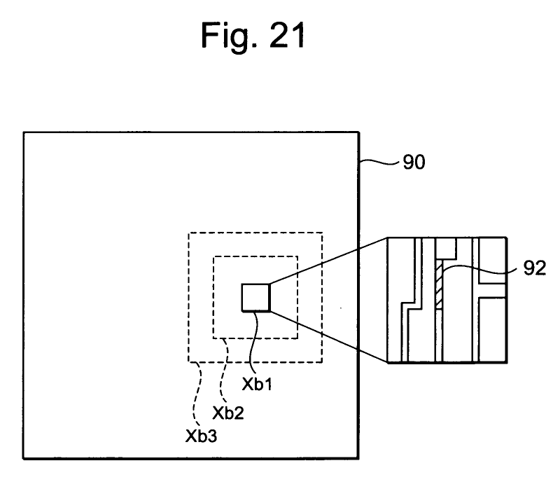

Subsequently, a description will be given of a layout parameter extracting method (the operation of the layout parameter extracting device) according to an exemplary embodiment of the present invention. FIG. 20 is a flowchart showing a layout parameter extracting method according to the exemplary embodiment of the present invention. Also, FIG. 21 is a schematic diagram showing a semiconductor device applied with the layout parameter extracting method according to the exemplary embodiment of the present invention. The layout parameter extracting method is applied to the design of the wiring in the circuit design of the semiconductor device 90 such as a semiconductor chip on which a semiconductor integrated circuit is mounted. For example, the method is used, for example, for layout parameter extraction of the subject wiring portion 92 (wiring width W, wiring interval S, wiring length L).

In order that the wiring model which is made higher in the precision in the wiring model library constructing method is taken in the design environment LPF, the layout parameter extracting method taking the corrected value dw into consideration is used to extract the wiring resistance and the wiring capacity. The extracted wiring resistance and wiring capacity are used for circuit simulation.

(1) Step S21

First, the wiring data correction unit 31 reads the layout data table 41. Then, the wiring data correction unit 31 selects one subject wiring from a plurality of subject wirings (including a case of the wiring portion) to be calculated. In an example of FIG. 21, a subject wiring portion 92 is selected.

(2) Step S22

Subsequently, the wiring data correction unit 31 extracts the wiring width W and the wiring interval S (designed values) of the subject wiring from the layout data table 41. Subsequently, the wiring data correction unit 31 determines the corrected value dw on the basis of the wiring width W (designed value) with reference to the wiring model table 42 (wiring model table b 24) (FIG. 16A). Then, the wiring data correction unit 31 corrects the wiring width W and the wiring interval S (designed values) to obtain the corrected wiring width Wa (=W+2×dw) and the corrected wiring interval Sa (=S−2×dw).

(3) Step S23

Then, the wiring data ratio calculation unit 32 extracts the number of terms i and the region Xi (the dimension of one side) on the basis of the wiring width Wa corrected by the wiring data correction unit 31 with reference to the wiring model table 42 (wiring model table b 24) (FIGS. 16B to 16C). In an example of FIG. 21, the number of terms i is 3, and the number of terms i and the region Xi is Xb1, Xb2, and Xbc. Then, the wiring data ratio calculation unit 32 calculates the wiring data ratio D(Xi) in the respective regions Xi by using Expression (4) on the basis of the wiring width Wa, the wiring interval Sa, the number of terms i, and the region Xi. Also, the wiring data ratio calculation unit 32 extracts the weighting coefficient we(Xi) in the respective regions Xi on the basis of the wiring width Wa and the region Xi with reference to the wiring model table 42 (wiring model table b 24) (FIG. 16D). Then, the wiring data ratio calculation unit 32 calculates the wiring data ratio Deff through Expression (2) on the basis of the wiring data ratio D(Xi) in each of the regions Xi, and the weighting coefficient we(Xi) corresponding to it.

(4) Step S24

Then, the wiring film thickness calculation unit 33 extracts the slope “Slope”, and the film thickness T05 at the wiring data ratio Deff=0.5 on the basis of the corrected wiring width Wa and the corrected wiring interval Sa with reference to the wiring model table 42 (wiring model table b 24)(FIGS. 16E to 16F). Then, the wiring film thickness calculation unit 33 calculates the wiring film thickness T through Expression (3) on the basis of the slope “Slope”, the film thickness T05, and the wiring data ratio Deff obtained by the wiring data ratio calculation unit 32.

(5) Step S25

On the other hand, the wiring data extraction unit 34 extracts the wiring width W, the wiring interval S, and the wiring length L (designed values) of the subject wiring from the layout data table 41.

(6) Step S26

Then, the wiring data extraction unit 34 extracts the narrowed amount Ba of the wiring width on the bottom surface side, the thickness Ths of the sub metal 114, the thickness Thb of the sub metal 115, the slope A of the side surface, and the resistivity ρ of the core metal 113, on the basis of the wiring width W and the wiring interval S with reference to the wiring model table 42 (wiring model table a 23) (FIGS. 10A to 10E).

(7) Step S27

The wiring correction configuration calculation unit 35 determines the configuration of the corrected wiring on the basis of the wiring film thickness T calculated by the wiring film thickness calculation unit 33, and the narrowed amount Ba of the wiring width on the bottom surface side, the thickness Ths of the sub metal 114, the thickness Thb of the sub metal 115, and the slope A of the side surface.

(8) Step S28

The RC extraction unit 36 calculates the wiring resistance on the basis of the configuration of the wiring determined by the wiring correction configuration calculation unit 35, the resistivity ρ of the core metal 113 in the wiring model table 42 (wiring model table a 23) (FIG. 10E), and the layout data table 41.

In the above manner, the layout parameter extraction can be executed by the aid of the wiring model according to this exemplary embodiment.

In the above manner, in the case where the wiring model in this exemplary embodiment is taken in the LPF, the correction value dw is given as an input (wiring model table 42), and the wiring data ratio is not calculated from the designed value, but values obtained by thickening all the wirings by the correction value d are used for calculation of the wiring data ratio (Steps S22 to S23). In this case, another dimension representative of the wiring configuration is not subjected to correction with the correction value dw (Steps S25 to S26). That is, the layout information (dw correction) for the wiring data ratio extraction and the layout information (no dw correction) for extraction of the wiring width and the wiring interval are dealt with, separately. In this way, the dimension and the parameter indicative of the configuration of the wiring are not equally corrected, but only an influential parameter is corrected, thereby making it possible to remarkably improve the design precision while keeping a small change caused by the correction.

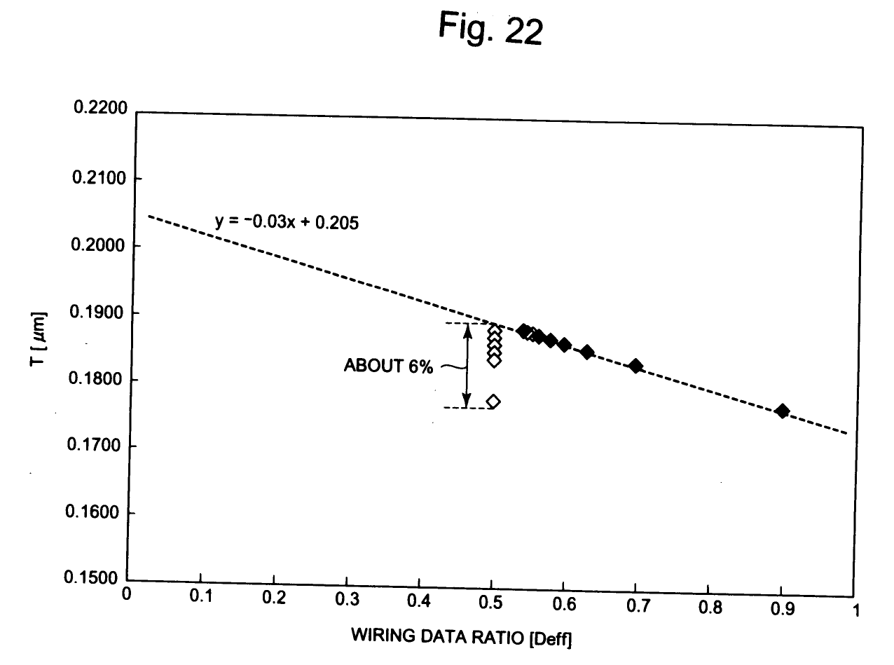

FIG. 22 is a graph showing the effect of the layout parameter extracting method according to this exemplary embodiment of the present invention. The axis of ordinate is representative of the wiring film thickness T, and the axis of abscissa is representative of the wiring data ratio Deff, respectively. The axis of ordinate is representative of the wiring film thickness T, and the axis of abscissa is representative of the wiring data ratio Deff, respectively. This shows the results that how a model error (wiring resistance, wiring capacity) caused by the wiring data ratio error in calculation using no correction value dw is contained in 65 nm node generation is calculated. This is based on data at the time of developing the 65 nm node wiring process. The slope “Slope” uses −0.003 as a result of evaluation at the time of the process development, and T05 is T05=0.19 μm when the subject wiring is the wiring width Wlayout/wiring interval Slayout of the subject wiring =0.1 μm/0.1 μm. Also, 2×dw=0.08 μm is met. The results of the calculating method using no correction value dw are indicated by outline rhombuses, and the results of the calculating method using the correction value dw according to this exemplary embodiment are indicated by black rhombuses.

The values in the graph express the peripheral wiring WD dependency of the model error (wiring film thickness T). In the calculating method using no correction value dw, the model error is increased more as the peripheral wiring WD is smaller, and in the 65 nm process minimum wiring width 0.1 μm, the model error of about 6% is included therein. In this case, the wiring resistance has a relationship of 1:1 with respect to an error in the wiring cross section, and likewise, an error of about 6% in the wiring resistance is included therein. Then, the wiring capacity is of an error of about 4%. In the manner using the correction value dw according to this exemplary embodiment, the error can be canceled.

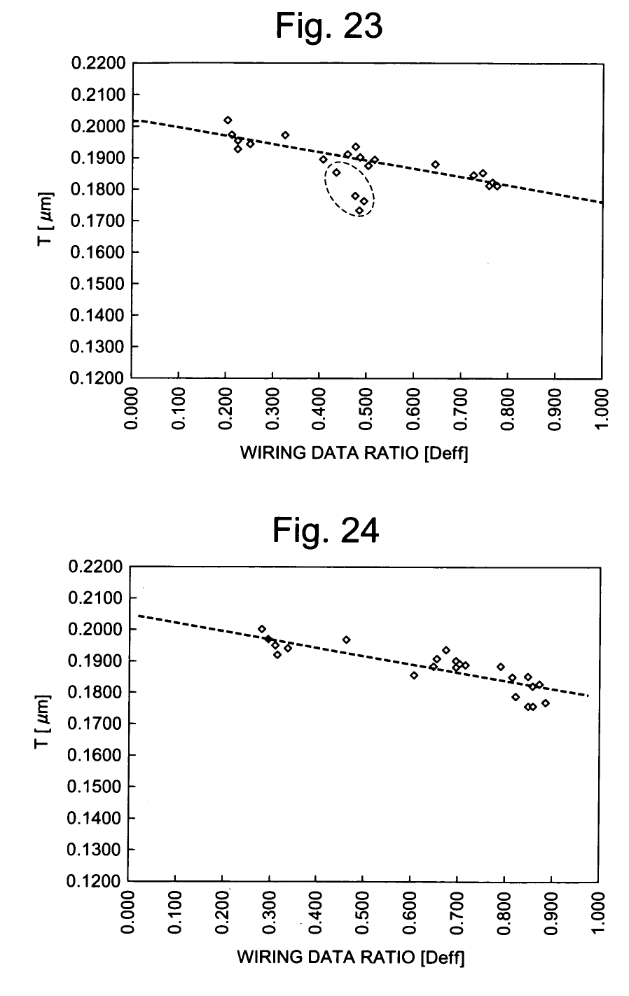

Also, FIG. 23 is a graph showing the measured graph in the calculating method using no correction value dw. FIG. 24 is a graph showing the measured data in the calculating method using the correction value dw according to this exemplary embodiment of the present invention. In both of those graphs, the axis of ordinate is representative of the wiring film thickness T, and the axis of abscissa is representative of the wiring data ratio Deff, respectively. FIG. 23 shows the results of the calculating method using the measured value at the time of developing the 65 nm node with no correction value dw, and FIG. 24 shows the results of the calculating method using the correction value dw, respectively. In the calculating method using no correction value dw (FIG. 23), a part of pattern (a point of a region surrounded by a dashed line) dissociates from the model value (broken line: physical ideal line). However, in the calculating method using the correction value dw (FIG. 24), it can be confirmed that all of the points substantially coincide with the model value.

As described above, when the CMP process is considered, an error is included in the wiring data ratio calculated from a certain designed value in the calculating method using no correction value dw. However, in the calculating method using the correction value dw according to the present invention, the effective correction value dw is extracted in the CMP process, thereby making it possible to calculate the physically correct wiring data ratio. As a result, the model error occurring in the calculating method using no correction value dw can be canceled, to thereby enable the precision to be more improved.

The program (exemplification: program for the wiring model library constructing method or program for the layout parameter extracting method), and the data structure (exemplification: wiring model library) according to the present invention may be recorded in a recording medium readable by a computer and read in an information processing device from the storage medium.

The invention may also provide:

A program for allowing a computer to execute a wiring model library constructing method using a wiring model library constructing device with a correction value calculation unit, a wiring model parameter calculation unit, and a wiring model table generation unit, the method including:

obtaining a correction value of wiring widths on the basis of a plurality of first wiring area ratios and a first wiring film thickness of a plurality of first subject wirings in a plurality of first test wiring patterns each having the first subject wiring and a plurality of first peripheral wrings and being different in the wiring width and wiring interval from each other by the correction value calculation unit;

obtaining a relationship between the wiring film thickness and the corrected wiring area ratio on the basis of a plurality of second wiring area ratios corrected with the correction value and a second wiring film thickness of a plurality of second subject wirings in a plurality of patterns including at least one of a plurality of first inner patterns in each of a plurality of second test wiring patterns including the plurality of first inner patterns each having the second subject wiring and a plurality of second peripheral wirings and being different in the wiring width and wiring interval from each other by the wiring model parameter calculation unit; and

storing data indicative of a relationship of the correction value, the wiring thickness, and the corrected wiring area ratio in association with the wiring width in a storage unit by the wiring model table generation unit.

In the program above, the obtaining the correction value of the wiring width may include a step of obtaining the correction value from the dependency of the first wiring film thickness on the plurality of wiring area ratios corrected with the correction value through linear approximation using the correction value as a parameter by the correction value calculating unit.

In the program above, the obtaining the relationship between the wiring film thickness and the corrected wiring area ratio may include a step of obtaining the weighting coefficient from the dependency of the plurality of second wiring film thicknesses on the corrected wiring area ratio calculated by the plurality of second wiring area ratios corrected with the correction value and weighted with the first weighting coefficient through approximation using the weighting coefficient as a parameter by the wiring model parameter calculation unit.

The invention may further provide a program for allowing a computer to execute a layout parameter extracting method using a layout parameter extracting device with a storage unit, a wiring data correction unit, a wiring data ratio calculation unit, a wiring film thickness calculation unit, a wiring correction configuration calculation unit, and a resistance and capacity extraction unit, the method including:

extracting a correction value of a subject wiring from first data associating a wiring width stored in a storage unit with a correction value on the basis of the wiring width of the subject wiring extracted from layout data stored in the storage unit to correct the wiring width of the subject wiring with the extracted correction value by the wiring data correction unit;

extracting a first wiring model parameter related to the wiring area ratio of the subject wiring from second data stored in the storage unit on the basis of the corrected wiring width of the subject wiring, and stored to associate the corrected wiring width with the wiring model parameter to calculate the wiring area ratio of the subject wiring on the basis of the corrected wiring width of the subject wiring and the first wiring model parameter by the wiring data ratio calculation unit;

extracting a second wiring model parameter related to the wiring film thickness from the second data on the basis of the corrected wiring width of the subject wiring to calculate a wiring film thickness of the subject wiring on the basis of the second wiring model parameter and the wiring area ratio of the subject wiring by the wiring film thickness calculation unit;

determining the wiring configuration of the subject wiring on the basis of the wiring width, a wiring interval, and a wiring length of the subject wiring which are extracted from the layout data, and the wiring film thickness of the subject wiring by the wiring correction configuration calculation unit; and

calculating a wiring resistance and a wiring capacity related to the subject wiring on the basis of third data stored in the storage unit and associating the wiring capacity with the wiring configuration, and the wiring configuration of the subject wiring by the resistance and capacity extraction unit.

In the program above, the first wiring model parameter may include the number of a plurality of regions set in the periphery of the subject wiring when calculating the wiring area ratio of the subject wiring, the respective sizes of the plurality of regions, and the respective weighting coefficients of the plurality of regions, and

a step of calculating the wiring area ratio of the subject wiring may include a step of adding a product of the wiring area ratio and the weighting coefficient which are calculated in each of the plurality of regions to calculate the wiring area ratio of the subject wiring.

In the program above, the second wiring model parameter may include a parameter of a mathematical formula representative of a relationship between the wiring film thickness and the wiring area ratio, and

the step of calculating the wiring film thickness of the subject wiring may include a step of calculating the wiring film thickness of the subject wiring on the basis of the mathematic formula including the parameter and the wiring area ratio of the subject wiring.

In the program above, the layout parameter extracting device may further include a correction value calculation unit, a wiring model parameter calculation unit, and a wiring model table generation unit,

the method may further include:

obtaining a correction value of the wiring width on the basis of a plurality of first wiring area ratios and a first wiring film thickness of the plurality of first subject wirings in a plurality of first test wiring patterns each having a first subject wiring and a plurality of first peripheral wrings and being different in the wiring width and wiring interval from each other by the correction value calculation unit;

obtaining a relationship between the wiring film thickness and the corrected wiring area ratio on the basis of a plurality of second wiring area ratios corrected with the correction value and a second wiring film thickness of the plurality of second subject wirings in a plurality of patterns including at least one of the plurality of inner patterns in each of a plurality of second test wiring patterns including a plurality of first inner patterns each having the second subject wiring and a plurality of second peripheral wirings and being different in the wiring width and wiring interval from each other by the wiring model parameter calculation unit; and

storing the correction value in association with the wiring width as the first data, and a wiring model parameter indicative of a relationship of the wiring film thickness and the corrected wiring area ratio in association with the wiring width as the second data, in a storage unit by the wiring model table generation unit.

The invention may also provide a layout parameter extracting device, including:

a storage unit that stores layout data related to wiring, first data associating a wiring width with a correction value, second data stored to associate the corrected wiring width with the wiring model parameter, and third data associating a wiring capacity with a wiring configuration therein;

a wiring data correction unit that extracts the correction value of the subject wiring from the first data on the basis of the wiring width of a subject wiring which is extracted from the layout data to correct the wiring width of the subject wiring with the extracted correction value;

a wiring data ratio calculation unit that extracts a first wiring model parameter related to the wiring area ratio of the subject wiring from the second data on the basis of the corrected wiring width of the subject wiring to calculate the wiring area ratio of the subject wiring on the basis of the corrected wiring width of the subject wiring and the first wiring model parameter;

a wiring film thickness calculation unit that extracts a second wiring model parameter related to the wiring film thickness from the second data on the basis of the corrected wiring width of the subject wiring to calculate a wiring film thickness of the subject wiring on the basis of the second wiring model parameter and the wiring area ratio of the subject wiring;

a wiring correction configuration calculation unit that determines the wiring configuration of the subject wiring on the basis of the wiring width, a wiring interval, and a wiring length of the subject wiring which are extracted from the layout data, and the wiring film thickness of the subject wiring; and

a resistance and capacity extraction unit that calculates a wiring resistance and a wiring capacity related to the subject wiring on the basis of third data and the wiring configuration of the subject wiring.

In the layout parameter extracting device above, the first wiring model parameter may include the number of a plurality of regions set in the periphery of the subject wiring when calculating the wiring area ratio of the subject wiring, the respective sizes of the plurality of regions, and the respective weighting coefficients of the plurality of regions, and

the wiring data ratio calculation unit may add a product of the wiring area ratio and the weighting coefficient which are calculated in each of the plurality of regions to calculate the wiring area ratio of the subject wiring.

In the layout parameter extracting device above, the second wiring model parameter may include a parameter of a mathematical formula representative of a relationship between the wiring film thickness and the wiring area ratio, and

wherein the wiring film thickness calculation unit calculates the wiring film thickness on the basis of the mathematic formula including the parameter and the wiring area ratio.

The layout parameter extracting device above, may further include:

a correction value calculation unit that obtains a correction value of wiring widths on the basis of a plurality of first wiring area ratios and a first wiring film thickness of a plurality of first subject wirings in a plurality of first test wiring patterns each having the first subject wiring and a plurality of first peripheral wrings and being different in the wiring width and wiring interval from each other;

a wiring model parameter calculation unit that obtains a relationship between the wiring film thickness and the corrected wiring area ratio on the basis of a plurality of second wiring area ratios corrected with the correction value and a second wiring film thickness of a plurality of second subject wirings in a plurality of patterns including at least one of a plurality of first inner patterns in each of a plurality of second test wiring patterns including the plurality of first inner patterns each having the second subject wiring and a plurality of second peripheral wirings and being different in the wiring width and wiring interval from each other; and

a wiring model table generation unit that stores in the storage unit the correction value in association with the wiring width as the first data, a wiring model parameter indicative of a relationship of the wiring film thickness and the corrected wiring area ratio in association with the wiring width as the second data.

The present invention is not limited to the above respective exemplary embodiments, and it is apparent that the respective exemplary embodiments can be appropriately modified or changed without departing from the technical concept of the present invention.

Further, it is noted that Applicant's intent is to encompass equivalents of all claim elements, even if amended later during prosecution.

What is claimed is:

1. A wiring model library constructing method, comprising:
providing a plurality of first test wiring patterns each having a first subject wiring and a plurality of first peripheral wirings placed adjacently to the first subject wiring, each of the first test wiring patterns having different wiring width and different wiring interval;
obtaining a correction value of wiring widths, on a basis of a respective first wiring area ratio of each of the first test wiring patterns and a respective first wiring film thickness of each of the first subject wirings in the plurality of first test wiring patterns;
providing a second test wiring pattern including a plurality of inner patterns each having a second subject wiring and a plurality of second peripheral wirings placed adjacently to the second subject wiring, each of the second test wiring patterns having different wiring width and different wiring interval;
obtaining a relationship between a wiring film thickness and an area ratio of a corrected wiring, on a basis of a plurality of second wiring area ratios of a corrected inner pattern obtained by correcting the inner pattern with the correction value, and a respective second wiring film thickness of each of the second subject wirings; and
storing data indicative of a relationship of the correction value, the wiring thickness, and the area ratio of the corrected wiring in association with the wiring width in a storage unit.

2. The wiring model library constructing method according to claim 1, wherein the obtaining the correction value of the wiring width includes obtaining the correction value from a dependency of the first wiring film thickness on the plurality of first wiring area ratios corrected with the correction value through linear approximation using the correction value as a parameter.

3. The wiring model library constructing method according to claim 1, wherein the obtaining the relationship between the wiring film thickness and the corrected wiring area ratio includes obtaining a first weighting coefficient from a dependency of the plurality of second wiring film thicknesses on the area ratio of the corrected wiring calculated by the plurality of second wiring area ratios corrected with the correction value and weighted with the first weighting coefficient through approximation using the first weighting coefficient as a parameter.

4. A wiring model library constructing device, comprising:
a correction value calculation unit that, based on a plurality of first test wiring patterns each having a first subject wiring and a plurality of first peripheral wirings placed adjacently to the first subject wiring, each of the first test wiring patterns having different wiring width and different wiring interval, obtains a correction value of wiring widths on a basis of a respective first wiring area ratio of each of the first test wiring patterns and a respective first wiring film thickness of each of the first subject wirings in the plurality of first test wiring patterns;
a wiring model parameter calculation unit that, based on a second test wiring pattern including a plurality of inner patterns each having a second subject wiring and a plurality of second peripheral wirings placed adjacently to the second subject wiring, each of the second test wiring patterns having different wiring width and different wiring interval, obtains a relationship between the wiring film thickness and an area ratio of a corrected wiring on a basis of a plurality of second wiring area ratios of a corrected inner pattern obtained by correcting the inner pattern with the correction value, and a respective second wiring film thickness of each of the second subject wirings; and
a wiring model table generation unit that stores data indicative of a relationship of the correction value, the wiring thickness, and the area ratio of the corrected wiring in association with the wiring width in a storage unit.

5. The wiring model library constructing device according to claim 4, wherein the correction value calculation unit obtains the correction value from a dependency of the first wiring film thickness on the plurality of first wiring area ratios corrected with the correction value through linear approximation using the correction value as a parameter.

6. The wiring model library constructing device according to claim 4, wherein the wiring model parameter calculation unit obtains a first weighting coefficient from a dependency of the plurality of second wiring film thicknesses on the area ratio of the corrected wiring calculated by the plurality of second wiring area ratios corrected with the correction value, and weighted with the first weighting coefficient through approximation using the first weighting coefficient as a parameter.

7. A layout parameter extracting method, comprising:
based on a wiring width of a subject wiring extracted from a layout data stored in a storage unit, extracting a correction value of the subject wiring from a first data associating the wiring width with a correction value stored in the storage unit;
correcting the wiring width of the subject wiring with the correction value extracted;
on a basis of the corrected wiring width of the subject wiring, extracting a first wiring model parameter related to a wiring area ratio of the subject wiring from a second data associating the corrected wiring width with a wiring model parameter stored in the storage unit;
calculating a wiring area ratio of the subject wiring, on a basis of the corrected wiring width of the subject wiring and the first wiring model parameter extracted;
extracting a second wiring model parameter related to the wiring film thickness from the second data, on a basis of the corrected wiring width of the subject wiring;
calculating a wiring film thickness of the subject wiring, on a basis of the second wiring model parameter and the wiring area ratio of the subject wiring;
determining a wiring configuration of the subject wiring, on a basis of the wiring width, a wiring interval, a wiring length, and a wiring film thickness of the subject wiring; and
calculating a wiring resistance and a wiring capacity related to the subject wiring, on a basis of third data stored in the storage unit and associating the wiring capacity with the wiring configuration.

8. The layout parameter extracting method according to claim 7,
wherein the first wiring model parameter includes a number of a plurality of regions set in a periphery of the subject wiring when calculating the wiring area ratio of the subject wiring, respective sizes of the plurality of regions, and respective weighting coefficients of the plurality of regions, and
wherein the calculating the wiring area ratio of the subject wiring includes adding a product of the wiring area ratio and the weighting coefficient which are calculated in each of the plurality of regions to calculate the wiring area ratio of the subject wiring.

9. The layout parameter extracting method according to claim 7,
wherein the second wiring model parameter includes a parameter of a mathematical formula representative of a relationship between the wiring film thickness and the wiring area ratio, and
wherein the calculating the wiring film thickness of the subject wiring includes calculating the wiring film thickness of the subject wiring on the basis of the mathematical formula including the parameter and the wiring area ratio of the subject wiring.
